(19) United States
(12) Patent Application Publication
(10) Pub. No.: US 2026/0243093 A1
(43) Pub. Date: Aug. 20, 2026

(54) QUICKLY-DEPLOYABLE AUTOMATED RAPID-SLIP-FORM CONCRETE PLACEMENT SYSTEM

(71) Applicant: Michael George BUTLER, Fort Bragg, CA (US)

(72) Inventor: Michael George BUTLER, Fort Bragg, CA (US)

(21) Appl. No.: 19/135,074

(22) PCT Filed: May 4, 2023
(86) PCT No.: PCT/US2023/021082

§ 371 Date: Jun. 2, 2025

Related U.S. Application Data
(60) Provisional application No. 63/338,032, filed on May 4, 2022.

(51) Int. Cl. E04G 21/04; E04G 11/22; E04G 17/06; E04G 21/06; E04G 21/08; F04B 15/02; G06K 7/10

(52) U.S. Cl. CPC E04G 21/0472; E04G 11/22; E04G 17/06; E04G 21/065; E04G 21/08; F04B 15/02; G06K 7/10366

(57) ABSTRACT

One aspect of the present invention pertains to systems for casting a concrete wall. Another aspect of the present invention pertains to methods of casting a concrete wall.

### CROSS-REFERENCE TO RELATED APPLICATIONS

The present application is a National Stage entry from PCT Application PCT/US23/21082, filed May 4, 2023, which claims benefit of U.S. Patent Application Ser. No. 63/338,032, titled “RAPIDLY-DEPLOYABLE AUTOMATED WALL-CONCRETE PLACEMENT SYSTEM,” to Michael George BUTLER, filed May 4, 2022. The present application is related to U.S. Patent Application Ser. No. 62/446,444, titled “Methods and Devices to Make Zero-Slump-Pumpable Concrete,” to Michael George BUTLER, filed Jan. 15, 2017 and “APPARATUSES AND SYSTEMS FOR AND METHODS OF GENERATING AND PLACING ZERO-SLUMP-PUMPABLE CONCRETE”, to Michael George BUTLER, filed Jan. 16, 2018; and U.S. Patent Application Ser. No. 62/793,868, titled “ADDITIVE LAYERING SYSTEMS FOR CAST-CONCRETE WALLS” to Michael George BUTLER, filed Jan. 19, 2019; and U.S. Patent Application Ser. No. 62/830,445, titled “APPARATI TO COMPENSATE FLOW VARIATIONS OF A PISTON PUMP, PARTICULARLY ALLOWING CONSTANT RATE ROBOTIC PLACEMENT OF CONCRETE”, to Michael George BUTLER, and U.S. Patent Application Ser. No. 62/834,923, titled “VERY RAPID CONCRETE SLIP FORMING OVER EXTENSIVE VERTICAL SURFACES WITH REMOTELY CONTROLLED AND AUTOMATED SYSTEMS” to Michael George BUTLER, filed Apr. 16, 2019; and PCT Patent Application PCT/US22/51878, titled “VISCOSITY CONTROL SYSTEMS FOR IMPROVEMENT TO CONCRETE, 3D PRINT MATERIAL, SHOTCRETE, AND OTHER SCULPTABLE MEDIA” to Michael George BUTLER, filed Dec. 5, 2021; and U.S. Patent Application Ser. No. 63/300,048, titled “DIGITALLY-CONTROLLED WALL-BUILDING SYSTEMS AND METHODS” to Michael George BUTLER, filed Jan. 16, 2022. The contents of all of these applications and patents are incorporated herein in their entirety by this reference for all purposes.

### BACKGROUND

Construction of concrete walls using contemporary automated-placement of concrete, such as present-day 3D concrete printing (3DCP), generally can use only specialized mortar, and cannot include code-required vertical reinforcement-due to present limitations of contemporary additive manufacturing layered-filament processes. So, existing automated processes generally require material that is many-times-more expensive, yet still cannot meet International Building Code structural requirements for reinforced concrete, so subsequent reinforced concrete structure must be included. The layered deposition process of 3DCP does not allow vibrational consolidation, nor necessary confinement that makes vibration effective for consolidation, which is a code-required aspect of concrete placement, and totally necessary with pre-situated reinforcing. However, the 3DCP layered deposition process does not allow any pre-situated reinforcing, because that interferes with the tool path of the print nozzle.

The 3DCP process does not provide a finished flat surface, even with “side-trowel” attachments. Additionally, the geometry control for these methods of automated placement of concrete involve very expensive robotics or an oversized, expensive gantry system that costs thousands of dollars just to relocate and erect at a jobsite. Furthermore, 3DCP cannot use in service construction equipment, while that new equipment is way too expensive and far too slow to be of practical use for most construction projects. For the construction of concrete walls, the present disclosure presents one or more solutions for one or more problems in concrete construction.

### SUMMARY

One aspect of the present invention pertains to systems for casting a concrete wall. Another aspect of the present invention pertains to methods of casting a concrete wall.

It is to be understood that the invention is not limited in its application to the details of construction and to the arrangements of the components set forth in the following description. The invention is capable of other embodiments and of being practiced and carried out in various ways. In addition, it is to be understood that the phraseology and terminology employed herein are for the purpose of description and should not be regarded as limiting.

### BRIEF DESCRIPTION OF THE DRAWINGS

FIG. 1 shows a wall concrete placement system placing concrete against rigid insulation.

FIG. 1A shows three major components of a wall concrete placement system.

FIG. 2 shows a positioning frame with a lifting platform, guiding a low-profile concrete placement device, placing concrete against rigid insulation.

FIG. 2A shows a low-profile concrete placement device with a retractable flow confinement system.

FIG. 3 shows a wall concrete placement system, with a mobile platform, placing concrete against rigid insulation.

FIG. 3A shows variations of components of the wall concrete placement system.

FIG. 4 is a side-view of a tall-nozzle concrete placement device with elements of a wall brace.

FIG. 4A shows a dynamic tie device.

FIG. 5 is a section view showing a vertical travel system and a nozzle-integral actuating vibrator.

FIG. 6 is a closer section view showing a horizontal travel system and a slip-form lubrication system.

FIG. 7 is a front-face view showing a mixing nozzle with integral actuating vibrators and dynamic ties.

FIG. 8 is a top view of a wall concrete placement system showing a control joint creator.

FIG. 9 is a side view of a low-profile concrete placement device showing rotating-actuating vibrators and magnetic ties.

FIG. 10 is a top view showing a low-profile concrete placement device motion and rotating-actuating vibrators in both operating positions.

FIG. 11 shows a back view of a wall concrete placement system with a low-profile concrete placement device.

FIG. 12 is two side views of a low-profile concrete placement device showing a pivoting-plunging vibrator in retracted and extended positions.

FIG. 13 is two side views of a low-profile concrete placement device showing a flow confinement system, with an electromagnetic tie system, and plunging vibrators, in retracted and extended positions.

FIG. 14 is two top views of a low-profile concrete placement device showing a flow confinement system, with an electromagnetic tie system, and plunging vibrators, in retracted and extended positions.

FIGS. 15A and 15B are two side views of a low-profile concrete placement device showing a modified flow confinement system, with a contact-activated electromagnetic tie system, in extended and sealed-top position.

FIG. 16 is a side view of a wall concrete placement system with a swivel-pipe concrete placement device.

FIG. 17 is a top view of a wall concrete placement system with a swivel-pipe concrete placement device.

FIGS. 18A and 18B show face views of a swivel-pipe concrete placement device in two different positions.

FIG. 19 shows various section views of a control joint creator in extended and retracted positions.

FIG. 20 shows elements of an electromagnetic actuator.

FIG. 21 shows an articulating magnetic tie system attached to a flow confinement system.

FIGS. 22A and 22B are section/side views of an electromagnetic engager.

FIG. 23 is a section/top view of a permanent magnetic engager.

FIG. 24A shows a contact-activated electromagnet tie engaged with a rebar.

FIG. 24B shows a contact-activated electromagnet tie, engaged with a ledger channel, to provide a sealed connection.

FIG. 25A is a control diagram where concrete placement is advanced with a servo motor, where digital control can be modified by signals from a concrete pump.

FIG. 25B is a control diagram where concrete placement advancement is with a 3-phase motor controlled with a variable frequency device, which can be modified by signals from a concrete pump.

FIG. 25C is a control diagram where concrete placement advancement is driven by hydraulic flow that is proportional to concrete pumping action.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DESCRIPTION

For the following defined terms, these definitions shall be applied, unless a different definition is given in the claims or elsewhere in this specification. All numeric values are herein defined as being modified by the term “about,” whether or not explicitly indicated. The term “about” generally refers to a range of numbers that a person of ordinary skill in the art would consider equivalent to the stated value to produce substantially the same properties, function, result, etc. A numerical range indicated by a low value and a high value is defined to include all numbers subsumed within the numerical range and all subranges subsumed within the numerical range. As an example, the range 10 to 15 includes, but is not limited to, 10, 10.1, 10.47, 11, 11.75 to 12.2, 12.5, 13 to 13.8, 14, 14.025, and 15.

The term “linear actuator” is used throughout in the general sense as meaning any device that provides controlled motion along an axis (which can be stationary or rotating); this can include ball-screw-driven linear actuator systems, or pneumatic or hydraulic pressure-driven systems, or solenoid-activated devices, etc.

Various embodiments of the present invention may include any of the described features, alone or in combination. Other features and/or benefits of this disclosure will be apparent from the following description. The order of execution or performance of the operations or the processes in embodiments of the invention illustrated and described herein is not essential, unless otherwise specified. That is, the operations or the processes may be performed in any order, unless otherwise specified, and embodiments of the invention may include additional or fewer operations or processes than those disclosed herein. For example, it is contemplated that executing or performing a particular operation or process before, simultaneously with, contemporaneously with, or after another operation or process is within the scope of aspects of the invention.

The various elements of any of these devices disclosed herein can advantageously be combined with other devices in many different permutations. Generally, for the present disclosure, only a single example of each feature is given, and any of the other combinations of the features is not also shown, as it is typically apparent that these other combinations of the features can be made by persons of ordinary skill in the art in view of the present specification.

Commonly owned patents and applications such as those presented in the Cross Reference section above, may disclose systems and devices for concrete placement are generally not repeated here, but any necessary information will be clear to persons of ordinary skill in the art in view of the present specification. Such systems and devices include methods and systems of concrete modification, concrete flow control, synchronization with placement systems, etc. The systems disclosed can be automated, semi-automated, manually controlled, or any combination of these. For manual control, no modification is required to a conventional concrete pump having pulsating pumping action, but it is far preferable. For automated control, previously disclosed pulsation compensation can be implemented to facilitate automated placement, or the systems disclosed herein can adjust their actions to correspond to pump pulsations, and move all actions at a rate proportional to the volume of concrete moving, by measure of concrete flow rate by means previously disclosed. Concrete vertical placement rates on test projects have exceeded one foot per minute. In any case, video monitoring of the concrete placement process is beneficial.

One or more aspects of the present invention pertain to the technical field of construction. More specifically, one or more aspects of the present invention pertain to the placement of concrete for construction of a reinforced concrete wall, where the traditional concrete-form construction process, or a shotcrete process, is replaced with a relatively lightweight, portable, and very rapid vertical-slip-forming system, which can be automated, semi-automated, or manually operated.

Aspects of the present invention replaces traditional concrete forming, shotcrete processes, conventional vertical slip-forming, and other automated-placement means, such as 3D printing for some applications. Traditional forming and shotcrete require excessive amounts of labor cost, and shotcrete particularly exposes workers to health hazards of respirable crystalline silica. Typical vertical slip-forming processes require excessively heavy equipment, so are impractical for most concrete applications.

Embodiments of the present invention may provide a light, mobile and compact system that rapidly slip forms conventional concrete vertically in-situ, for creation of walls, in discrete sections that can be divided by required or preferred control joints. In most cases it is preferable to provide a series of vertical control joints in a cast-concrete wall, and so preferably placing concrete in separate sections that are divided by control joints—in that separate placements in sections of wall, improves the function, purpose and control of the joints.

With this concrete placement system, concrete is pumped into place and can be vibrationally consolidated, the preferred means of placement. The concrete can be modified in the pumping line, allowing rapid removal of very temporary confinement at the point of placement. The challenge of a new small vertical slip forming system, that easily relocates for each section of a wall, is to be able to place concrete at a rate fast enough to allow practical use of truck-delivered, ready-mix concrete. Making delivered concrete viable, provides very significant material, capital, and labor costs savings, faster completion, and improved code-acceptance and quality control, over site-mixing small batches of concrete.

In combination with a sufficiently rheology-modified or accelerated concrete mixture, this new practice, using pumped concrete, can vertically slip form a one-story-tall wall of concrete at a rate faster than a foot (30 cm) vertically per minute, completing a one-story-tall wall in under 8 minutes. A minimum viable vertical rate for this practice, that allows rapid enough concrete consumption to empty a typical delivery of concrete without entirely unacceptable delay, is in the range of 6 minutes per foot (30 cm) vertically, or about 5 cm per minute, while 15 cm vertically per minute is a reasonably good rate that can finish a one-story-tall wall in 45 to 60 minutes. Of course, the 8-minute wall is preferable. This rapid build rate is no problem for the present invention, the issue is the concrete material being able to stand up at that rate as it leaves the confinement of the slip form.

The primary embodiment of the system illustrated here is where concrete is placed against a vertical backing plane, such as the panels of rigid insulation shown, though this same system is more easily utilized to place concrete against an existing excavation or vertical surface (such as is commonly done with shotcrete); and the system can also be mirrored, at least the slip form aspects, and so utilized to define (simultaneously) both sides of a free-standing concrete wall. Alternatively, the means shown for bracing a backing plane of insulation panels to place concrete against, can be used for a positioning removable backing panel. Most examples shown utilize panels of foam. These panels can have stucco applied before or after the wall concrete is placed, conventionally or by new methods of previous disclosures. This method also improves the process using Structural Concrete Insulating Panels (SCIPs) and similar, in that it allows more rapid placement of concrete over the wire-reinforced panels, and in providing a flat surface. This method has the advantage over shotcrete in providing placement at full thickness to a finished surface, in a single pass. The methods utilizing plain foam panels is emphasized here because with these methods they allow the least expensive way to provide a highly insulated concrete wall, and so methods to facilitate use of plain panels is emphasized, even though most of the initial practical applications for these new methods is are such things as infrastructure, retaining walls, and large basements at property lines.

This concrete placement system can be utilized with any type of concrete or fluid that solidifies. In combination with a highly-rheology-modified or very-fast-setting material, it can create a condition where only a small portion of the confined material exerts fluid pressure, this being only in the portion undergoing vibration. If this portion of the material becomes an intense zone of vibrational consolidation, that consolidation process immediately increases the solidity of initial set of the material. Because of this, once the vibrational consolidation has ceased, so does the majority of the concrete fluid pressure. Then the zone of intense vibration can very rapidly relocate for adjacent material placement and consolidation. As the zone of confinement volume, and confined surface area, of fluid pressure for each successive placement can be very small, with that form pressure substantial dissipating almost immediately, the total form-pressure loading on the system at any moment is minimized.

This much lighter system loading allows a much lighter system to be used, allowing these new unconventionally-light methods of slip forming and bracing. A much lighter and more nimble slip forming system is now possible. New means of creating temporary ties are developed to resist the form-pressure only when and where needed, or permanent or more conventional form tie systems can be lighter altogether where a greater number of them are taking load, further reducing the strength and weight requirements of the total sip-form system. And in many cases, for ties can be omitted entirely.

This system can place concrete in full thickness of a wall at each placement action, and it can also provide an amount of temporary confinement below and adjacent to the placement zone, should any concrete modification have inconsistent effects—in needing variations in time to set up or thicken enough to remove 100% of confinement. In other words, modified concrete that has been vibrated into place, preferably is subsequently provided a lesser amount of confinement—to allow for a greater range of robustness for success in varied environmental conditions and properties of delivered concrete. This helps insure a rapid enough consumption of concrete to make inconsistent ready-mix concrete delivery viable, with a light and quickly-relocatable concrete slip form system, where the placement process is far more forgiving than is additive manufacturing of layered filaments of a cementitious mixture, known at 3D concrete printing (3DCP). With the present invention, it is possible to place concrete with a variable range of properties, even between deliveries for the same job, while 3DCP is far less forgiving, typically requiring a very highly-controlled cement-rich mortar.

There are problems with present technology in 3DCP (and other potential automated concrete placement methods not known at this writing) is that the only pumps contemporarily known that can pump concrete or mortar, at a precise and controlled enough rate for the process, are electrically-powered progressive cavity pumps, or similar slow extrusion pumps. Most often for 3DCP, two mortar pumps are required, with a second digitally-controllable extrusion pump metering mortar for the printing process. It is possible that such a pump can be hydraulically driven, though still based on a digitally-speed-controllable electric motor. Jobsites commonly will not have a sufficient power source for these types of electric motors that are powerful enough to move concrete at typical concrete pumping rates. Most 3DCP utilizes mortar as the controllable pumps they sized cannot handle coarse aggregate.

Precisely-controllable extrusion pumps are incapable of pumping conventional, delivered ready-mix concrete, so are not cost effective for most concrete construction. Another problem is that progressive cavity pumps do not handle large aggregate. Some will pass 9 mm aggregate, but only in low proportion, and in the process, the surprisingly-expensive rubber stator is quickly torn up and in need of replacement. It is far more practical, less expensive, and much faster if it were possible to be able to utilize most any of the gigantic fleet of in-service piston pumps for concrete, most of which are provided to contractors as a pumping service. The main problem is that engine-driven motors will not pump at a precisely-controllable rate.

This problem is solved by utilizing the concrete volume flow rate provided by a manually operated, or analog, concrete pump to also control a rate of automated concrete placement. To allow automated placement of concrete using the generally available piston concrete pumps—having significant variations in pumping rate (most commonly being “cylinder-switching” or “swing-tube” types of pumping systems), requires a new approach. The way to control of the effective rate of pumping with such a pump for automated concrete placement, is to first determine a given concrete pumping rate by that pump that is suitable for a given placement rate, and then link the control of the automated placement system motion advancement proportionally to that concrete pump rate, so they are synchronized, or at the least, so that the carriage rate of travel is responsive to the concrete pump rate. Thus, as the concrete pump rate varies, the control of the placement system can determine those variations and match them proportionately. In other words, the best way to integrate an analog system with a digital system is to determine or measure the analog rate, and then match the digital rate to it, and use measurement of changes in to that rate, to change the digital system correspondingly.

The placement rate can be linked using an electronic concrete pump control. Linking control information from the concrete pump to the control of the placement device motion, and/or to the duration of sequential-stationary placements, can provide a consistent automated placement, even when experiencing extreme and abrupt fluctuations of concrete flow rate (such as when the concrete pump abruptly and momentarily pauses pumping while switching cylinders). Consistent automated placement is now possible with conventional engine-driven concrete pumps, because this automated placement system can link to, and respond to, signals from the concrete pump control system, or from direct measurements of concrete flow volume. In other words, an analog concrete pump can be utilized for automated placement or additive manufacturing by determining its rate of pumping concrete, and the information used to control or adjust the rate of an automated concrete placement system. If the concrete surge fluctuations are smoothed, physically or electronically, then this average flow volume can be used as the basis for direct placement rate. Where the concrete pumping is not smoothed, it can be averaged to determine an average rate of placement, or the placement rate con correspond to it directly.

The conventional method physically resembling the present invention is vertical slip forming, a domain of a very heavy and specialized industry, that requires very heavy jacking equipment and yokes, above the area of concrete placement, to carry the load of multiple levels of scaffolding for people and equipment; the yokes and forms must be heavy enough to confine the concrete fluid pressure of all of the forming surfaces. Conventional vertical slip forming thus requires special heavy support-rods cast into the concrete, and significant space above the finished wall for the jacking and supporting equipment, so it is not cost effective for small footprints, and it cannot slip form right up to a horizontal plane-such as a floor, ceiling, or other lid. Additionally, it can only form both sides of a wall, so is not viable for applications such as slip forming against an excavated wall of a basement, for example.

Faster slip forming is now available using much lighter and less-expensive equipment, lowering cost and market accessibility, by omitting the jacks, the heavy yokes, and the scaffolding (as it does not need people for concrete placement), and so making small projects, such as residential applications, economically viable The present invention also replaces present day horizontal slip forming methods, with the same advantage of allowing use of lightweight less-expensive equipment, while also allowing concrete placement by pump-which present-day horizontal slip forming cannot do, so that the slip forming can now easily be accomplished at locations not adjacent to where a concrete truck can drive to.

Counterintuitively, for a reinforced concrete wall built this way, it is common to have the maximum rate of placement controlled by a necessarily thorough consolidation process, rather than by the concrete vertical buildability (hold shape after the form has relocated). This is why the present invention is focused on vibration systems, as a more effective vibrational consolidation is the means to both a faster placement rate and a better-quality result.

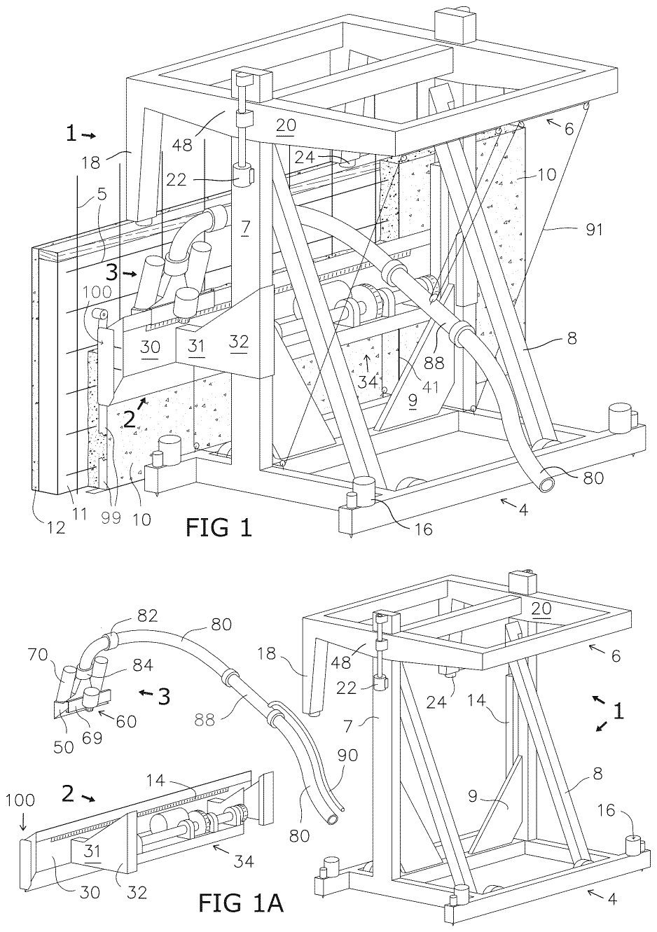

### FIG. 1 and FIG. 1A

These two figures show the same system, though FIG. 1A shows only the three major elements of the system, separated for clarity. This description applies to both drawing figures.

To provide material for a concrete wall, a concrete delivery hose 80 is attached to a source of pumped concrete, where it can be passed through an inline mixer 88, wherein the concrete is intermixed with an injected rheology modifier and/or set-accelerator, delivered though an admixture line 90. The resulting modified concrete can be made to hold a vertical surface shortly after modification, the time for a set sufficient to allow vertical stacking can range from immediately to five minutes, so that a traditional forming or slip-forming process is no longer required in order to build in-situ concrete walls. This type of concrete modification allows new placement methods such as disclosed herein and previously, though other means of providing a rapidly-stabilized cementitious material, even if being more expensive and/or less efficient, could also provide the necessary material properties allowing the advantages of placement system disclosed herein. That is, the present invention is independent of the preferred rheology modification of concrete. This geometry, in having a horizontal slip form member that can span between vertical control joints, allows for more rapid placement of concrete for a given vertical buildability property of the material, compared to other automated or digitally-controlled methods; and also allows for a more robust concrete placement process with given material property variables.

A wall concrete placement system is shown placing concrete against a vertical backing plane 11, in this case of rigid insulation, and in this case already having stucco cladding 12 attached, to create an in-situ concrete wall 10. Support of a backing plane or surface allows the benefit of confinement for improved vibrational consolidation and faster vertical build. If the concrete being placed has sufficiently supportive rheology, these methods can place concrete without the backing surface, as if 3D printing from the side, with the slip form element acting as a screed. This process would be very slow, as 3D printing is, but maintaining the advantage that pre-situated rebar can be present.

An array of a reinforcing bar 5 can be prepositioned. This reinforcing can be bars of welded wire mesh panels or independent rebars. Any supported backing vertical surface can be utilized in lieu of the foam panel shown, for this concrete placement from the front side. This can be an excavated surface or another temporary slip form surface like that disclosed here.

A positioning frame 1 is guiding a slip form system 2, while concrete is being placed by a concrete placement device 3, which could be described as a carriage or shuttle, where it can provide control of its movement and can vibrationally consolidate the concrete placement. These components are separated for clarity in FIG. 1A. The disclosures following consist of various embodiments of these essential components, any of which can be automated or manually operated. The wall concrete placement system consists of these three major components having these essential functions:
1) A frame for positioning and guiding a slip form, the guidance provided for one side of a wall.
2) A slip form that defines the surface of a wall, while moving in an essentially vertical direction, having its own means of effecting that travel, and linearly guiding a concrete placement device in essentially a horizontal direction.
3) A concrete placement device, having its own means of effecting horizontal travel, having a placement nozzle attached to a pressurized conduit for conveyance of concrete, that controls the placement of the pumped concrete.

The section of concrete wall being placed extends horizontally from the left end of a slip form beam 30, which can have a control joint creator 100; and to the right which is the edge of a previous section of concrete, so creating a control joint 41. The creation of the control joints is optional. For each wall section, the beam 30 provides horizontal guidance for the concrete placement device 3, which places concrete in small placements, moving horizontally for each placement, as a horizontal carriage system to control locations for concrete discharge. Each concrete placement can be made while the device 3 is moving, or temporarily held still, depending largely on its vibration system and whether that system can function during horizontal motion though concrete. The implication is use of the internal vibration systems disclosed presently or previously; though external vibrational systems disclosed previously can be used without restriction to placement device movement.

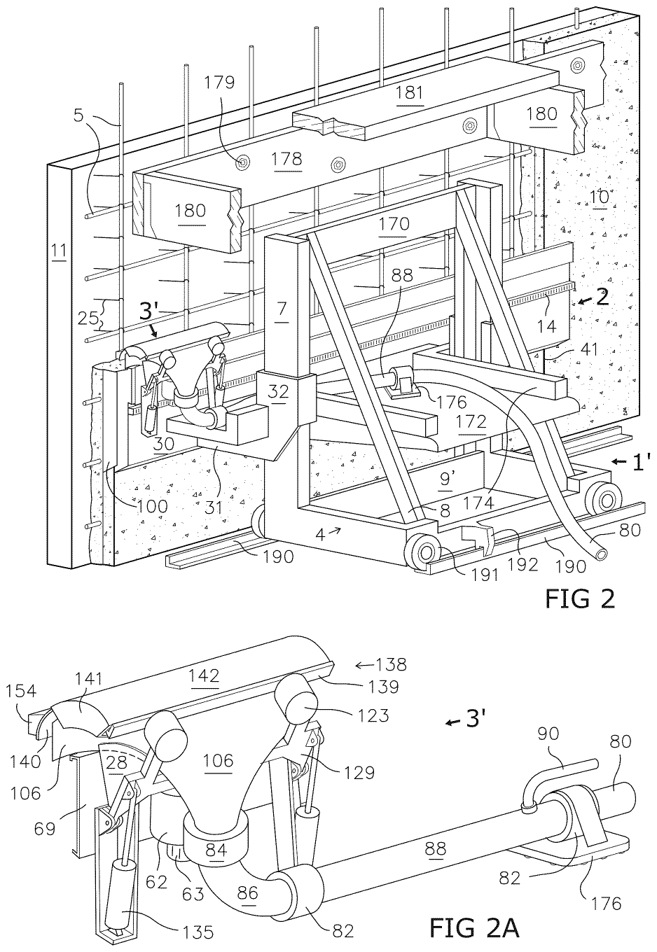

Device 3 can run the effective length of beam 30. Then, slip form system 2 will lift vertically, for a subsequent series of placements above the previous ones. A next-higher placement can start immediately above the previous-last placement, with device 3 then continuing in the opposite direction; or the device 3 can move back to a starting end while system 2 lifts, and then proceed with placements in the same direction for all placements—either way creating a concrete wall. The choice between these two options can depend upon the rheology and/or set of the modified concrete—whether a second placement is possible immediately above a previous one. An alternative sequence is described below per FIG. 2A. The device 3 makes a series of placements in a horizontal series, along beam 30, and the system 2 lifts for each new horizontal set of placements, until reaching the top of the wall—or a horizontal break in the wall, such as for a subsequent story. The starting elevation, where the bottom edge of beam 30 is along a slab floor or ground surface, will require concrete placement and vibrational consolidation through most of the vertical depth of the beam 30, and so this initial placement will generally require additional vibration than a typical “lift”. This all can be automated or manual. It is a practical combination to have the routine motions automated or semi-automated, with the device relocation, positioning, and startup be semi-automated or manual, preferably with physical, digital or GPS guidance.

In conventional vertical slip forming it is common practice to provide some draft to any slip form surface, in that the lower portion is set a bit further from the concrete surface than the upper portion, in order to reduce sliding friction. This application is typically less likely to require draft, as the concrete will tend to be less hardened during slipping than conventionally, though the practice can be used in the present application. Industry conventions for draft are suitable here, and this can include compensation for any torsional strain on beam 30 from supports 31 that are below the resultant of active fluid pressure.

The basic function of frame 1 is to provide guidance and support for slip form system 2, using an essentially horizontal plane, such as a concrete floor or earth surface, as a support for defining and holding the plane of the wall. Each of a leveling unit 16 (shown here as for a concrete floor condition) can provide adjustment to define the wall plane, and also can define the verticality of the beam 30 motion, in order to create in-situ control joints that are vertical. Shown here are linear actuators that adjust a spike vertically to create a point of support that also provides lateral resistance for the forces involved. Each of a vertical beam 7 would normally be adjusted parallel to, and a controlled distance from, the projected wall plane, and also the same for in-situ control joints, if they are to be used. Alternatively, the frame can be aligned to an existing wall surface, which can be the previous placement of concrete by this device, whether or not that concrete surface is vertical. Vertical beam 7 is braced by a strut 8 and/or a squaring plate 9, in perpendicular directions, or the like, so that each of the vertical beams are normal to a horizontal plane, for a vertical wall with vertical control joints. Alternately, the frame 1 can be set to any slope.

Frame 1 would be positioned a controlled distance from the wall plane, and so that a control joint is located as needed typically then subsequently “leveled” to make the wall and joint vertical. This process can utilize laser positioning and electronic levels, GPS, or any other positioning systems, including tracked robotic systems following telemetry or tool paths as defined by a digital model. The embodiment shown in FIG. 1 shows only simple wheels allowing manual mobility to reposition the frame for leveling at a new section of wall. A physical guide element can be prepositioned a set distance from the wall plane, in order to reference the location of frame 1. More sophisticated integral physical positioning systems that are presently in use with other construction systems can serve this purpose, including those of conventional slip forming systems, or GPS-based guidance.

This embodiment of the frame 1 has a rectangular base frame 4, with the leveling unit 16 at each corner, which serves to guide and brace the frame 1. An optional overhead frame 6, serves to provide support for a hose support system 91; and a means to temporarily brace the top of a wall, such as with one or more of a bracing arm 18 having a clamping linear actuator 24, or the like. Overhead frame 6 can be attached to frame 1 with a sliding connection 48 controlled by a linear actuator 22. This allows for a fit to walls of varying heights. Beam 20 can be made to have an aperture at a deeper cross-sectional size, to allow a rigid enough fit about vertical beam 7 so that the slip connection has minimal play from loadings at the ends. The other cross beams can be smaller and lighter.

The optional hose support system 91 has both terminal ends attached to the slip form system 2, and is arranged so that as a vertical travel system 34 lifts system 2 vertically, the portion of the cable passed through a pulley attached to the inline mixer 88 will also lift the mixer 88 the same or a similar amount. This provides control of hose 80, to align with placement device 3, and allows unrestricted motion of placement device 3, facilitating automated placement of concrete. As device 3 travels from mid beam 30 to each end, the cables supporting hose can swing to allow the hose movement toward and away from the wall as required; and as support of hose (via inline mixer in this example) is by a pulley, then hose can automatically self-center on frame, even if only one end is attached to system 2, providing half the lift action of beam 30, should that be preferred.

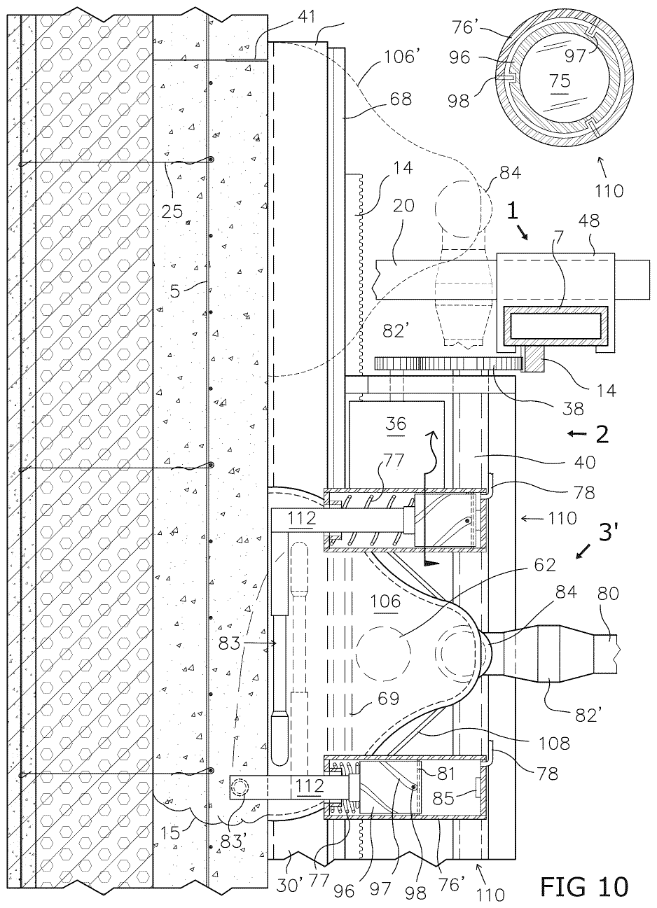

The control joint creator 100 can project from the face of beam 30 into the plane of concrete in order to help confine the concrete being placed at that end of the beam. To prevent bonding to the subsequent section of concrete to be placed, a separation strip 99 of bond breaking material can be dispensed from a roll as beam is lifted. This device is disclosed further in FIG. 10. Alternatively, a release agent can be applied to the concrete edge-surface created, to minimize bonding with subsequently placed concrete. In order to allow adjustment of a control joint location after the frame has been positioned and set into place, it can be helpful to have lateral adjustment at each beam support 31 connection to the beam 20. This option is not shown for clarity. The movement of the frame from a finished wall section to a new wall section can be of a motion entirely parallel to the wall, or it can adjust away from the wall, and then reposition in plane. The control joint creator usually needs to be retracted for a move.

The wall concrete placement system will generally also have lines for delivery of power, pneumatic, hydraulic and/or other controls for various systems disclosed, though the lines for delivery of these systems are not shown, for clarity. These lines running to the placement device 3 can beneficially be bundled with the concrete line 80.

### FIGS. 2 and 2A

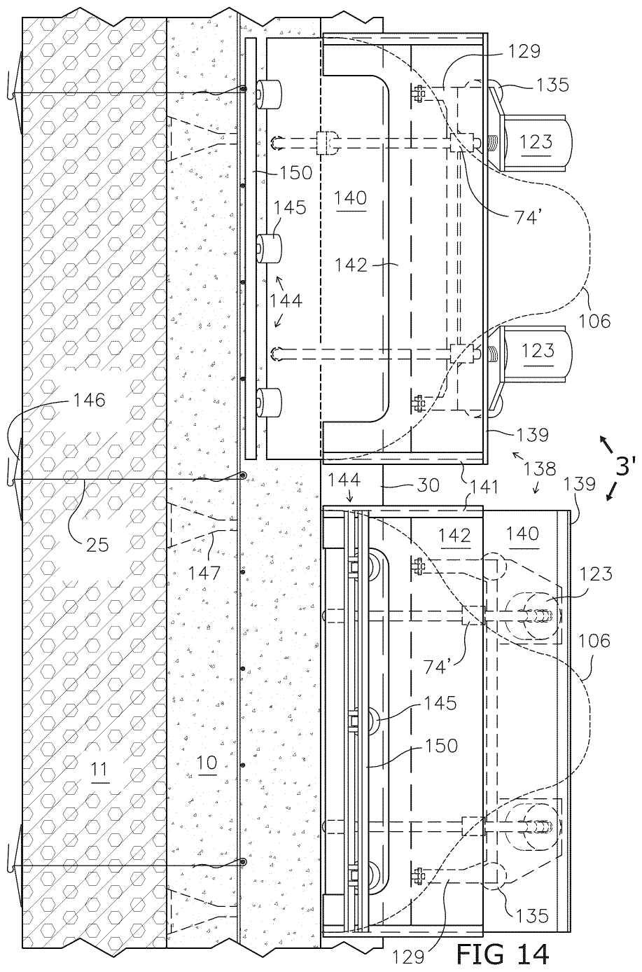

A wall of in-situ placed concrete has placement underway, with a frame 1′, the slip form system 2, and a low-profile placement device 3′. A previous placement of wall concrete 10 is to the right of the present placement process, separated by a control joint 41. A number of a stucco tie 25 are present, in this case tied to the rebars 5 that are vertical. At the far side of panel 11 these ties end in a bearing washer (145 of FIG. 14), or they can be ties to stucco wire reinforcing of already-placed stucco cladding. Ties such as these are required by building codes for maintaining attachment of stucco or brick veneer cladding, or the like, and to for purposes of the present invention, the stucco tie 25 can mean the tie for attachment to the wall of any cladding, veneer, stone or precast cladding, etc. For these methods the ties are most easily cast into the concrete wall (rather than making attachments to hardened concrete), preferably with a bend to develop anchorage. In this embodiment they are tied to rebars for anchorage, and also to allow then can be utilized to resist concrete fluid pressure. In combination with a temporary means of attachment to the rebar during the slip forming process, the ties hold the panel 11 in place. The temporary means of attachment can be by hooking onto or by controlled magnetic attachment to the rebars, such as with an articulating magnetic tie system 154 of FIG. 2A, with disclosures following.

The frame 1′ lifts a platform 172 with the slip form system. This platform can be used for support of the concrete delivery system (discussed below) in using a perimeter curb 174 to contain these elements. The curb can be used for support of another horizontal surface (not shown) that can be used for support of personnel.

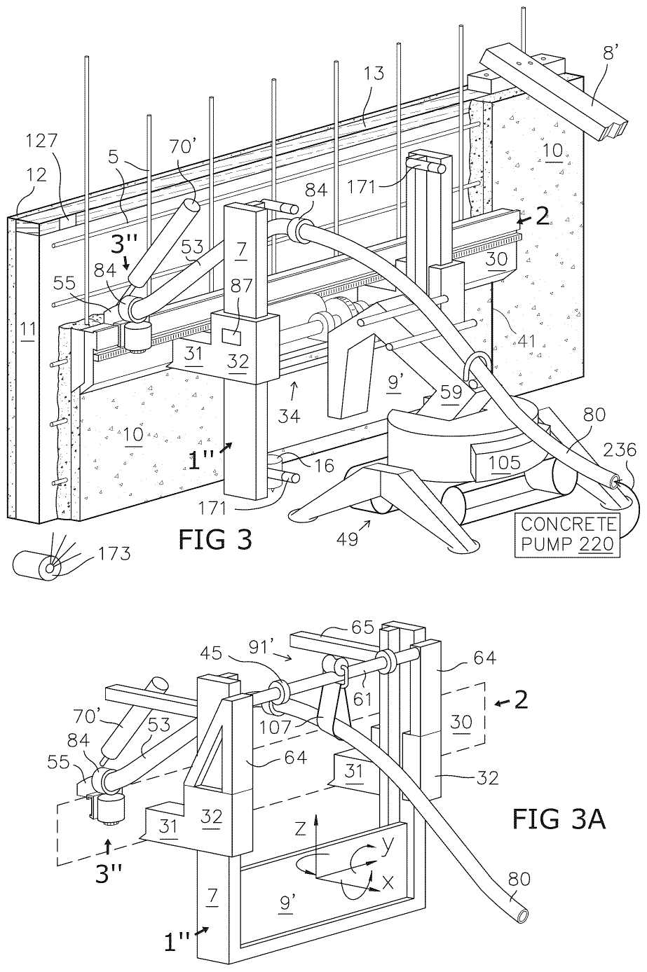

The low-profile device 3′ allows preplacement of temporary or permanent bracing at the top of wall backing plane 11, in that the low-profile design can operate clear of such members placed at any point along the top of the wall. This includes bracing such as 8′ shown in FIG. 3. In this example, the low-profile device can place concrete up to the bottom of a ledger member 178, and the concrete behind the ledger can be placed by conventional means. The ledger can have a temporary or permanent connection to the backing plane 11 and also can have a number of pre-positioned anchor bolts 179 that will get cast into the concrete wall. These anchors can be for support of a future floor and for out-of-plane bracing for the wall. The ledger 178 can be locked into plane with a number of a joist member 180, which can be as a skeleton of future floor framing—in being only a limited number of the joists—those that are needed to position the ledger, which can in turn position the top of the panels 11. A number of a plank 181, or other longitudinal member, can be fastened along the top of the ledger, to increase its straightness. One or more of the plank can be used for support in the subsequent placement of concrete behind the ledger. The joist members can be lightweight manufactured chord/web joists, truss members, or of light gage steel. Alternatively, this system can be shoring for construction purposes or placement of an in-situ concrete floor. The benefit to this method is that the “skeleton” can be more easily framed and squared on the existing floor, and then lifted as a unit (by novel means beyond the present disclosure), and then be efficiently utilized to define the location of wall planes.

The low-profile placement device 3′ has the concrete coming in from below, in order to clear the vertical beams 7′ over its horizontal travel. If the distance between the vertical beams is no greater than the length of the slip form beam 30, then this clearance is not an issue, and the concrete can enter the nozzle from most any direction. In this case, the vertical beams are spaced closer than the beam span to reduce weight, so the concrete delivery line needs management. In this solution, the swivel 84 attaches to an elbow 86. This can attach directly to the inline mixer 88 or to a length of hose. Shown here is a roller plate 176 that is strapped to a coupler 82 that connects mixer 88 to hose 80. The lateral movement of system 3′ can move mixer and/or hose over the platform 172, where they are confined by the curb 174.

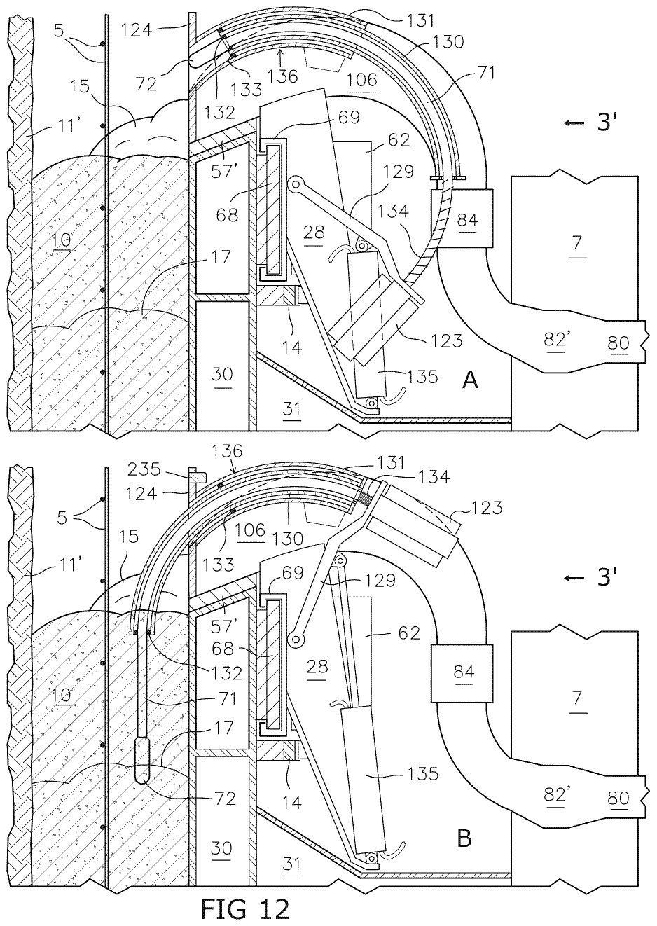

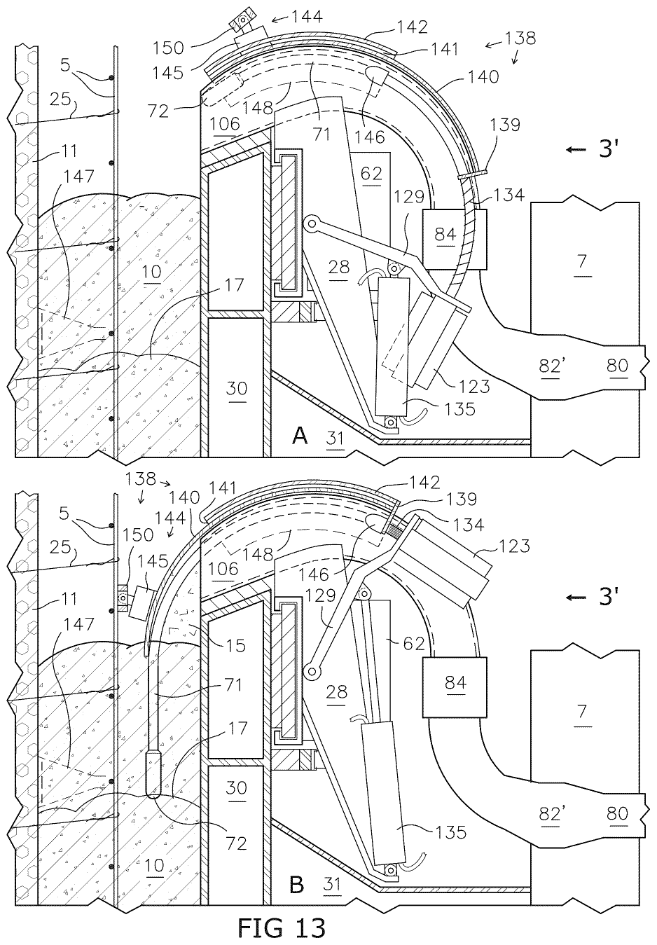

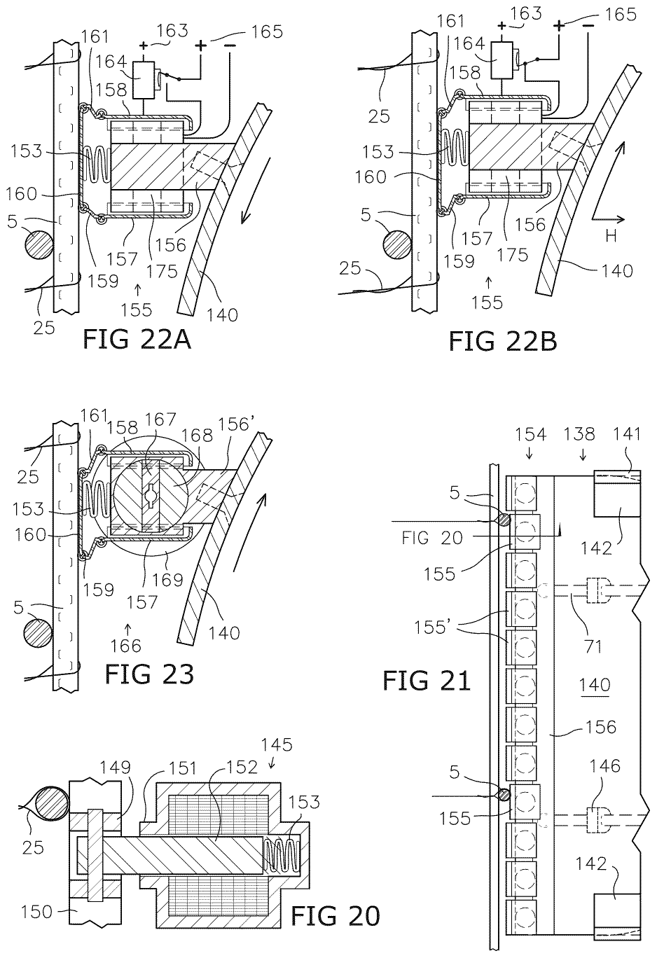

This embodiment of the nozzle 106 has a flow confinement system 138, which can extend into the plane of concrete placement to direct that flow downward, and can retract to clear pre-situated elements in that plane. The system consists of a flow-directing lid 140, that is guided by concentric guide 141, aligned with a fixed lid 142. Extension of lid 140 is made by a pair of an actuator 135 rotating arm 129, that is linked to each of a vibrator motor 123. Rotation of arm extends the lid and the vibrator shafts (not visible in these images) into the concrete. The extension of lid can be exploited to utilize an articulating magnetic tie system 154. Discussion at FIGS. 13 and 14 go into more detail on system 136. Explanation of this magnetic tie system 154 is given at FIGS. 20, 21A and 21B.

The means of positioning and holding position for frame 1′ can be using two of a track 190 (or only one of a track in combination with a guiding track at the top). The optional tracks 190 can be set to guide the wheels 191 along a plane that defines the wall. The tracks can have conventional height adjustment and leveling devices, or shims, to level the beam 30, and can be fastened sufficiently to the floor or ground by typical means, etc. In position, they can be utilized with the frame 1′ to locate the rim member 178 for positioning onto the wall. Here the tracks are shown as steel angle sections, such as L2×2×¼, but they can be typical rail tracks that work with flanged wheels, or the angles can be turned with the 90-degree corner up, etc. Because the system has horizontal loads in the plane of the wall, such as that force against the control joint creator, a clamp 192, or some means of holding position, is necessary. The clamp can be a manual over-center clamping device, or an automatically operated solenoid-actuated brake, etc. This is shown for clarity on the rail away from the wall, but if not on both rails, on the rail close to the wall is more effective. Alternatively, the positioning of frame 1′ can be any of the other methods disclosed elsewhere.

### FIG. 3

The description of FIG. 1 significantly applies to this. The aspects that vary are described below. This shows a wall concrete placement system that uses a mobile platform for locomotion and frame positioning. The embodiment shown also allows a low-profile frame so that it can travel underneath prepositioned brace members, etc., avoiding a need for the frame to provide backing planes for wall concrete placement.

A mobile platform 49, which can be a remotely-controlled tracked vehicle, such as those used for concrete demolition, or any similar type of mobile vehicle. Alternatively, this can be a mobile robot with geo positioning or a physical track system to reference position, with motions based on a digital model. An articulating arm 59, can preferably be of at least 3 arm segments to allow an articulating connection to squaring plate 9′ by an attachment at the end of arm 59, so that the frame 1″ can be located and articulated for concrete placement in the intended plane. This support by the platform can vary. The leveling support feet that can be lowered, as is typical on the demolition vehicles, can be linked to positional and leveling systems on the frame 1. A typical sequence would be for the platform 49 to move into location for supporting the frame, where at least one edge of the concrete placement is defined by stationing at that location, next, to self-level the platform 49, then to utilize the arm to move the frame to a defined plane and a predetermined height, with rotational corrections made about the controlled vertical-rotational axis of the mobile platform.

Depending on the size and weight of the mobile platform, a counterweight 105 can be attached to support the weight of the concrete placement systems during relocation. The entire weight of the system is considered if placement above a given floor system is required, and the lightweight feature of such a tracked vehicle can make this possible for a typical floor. When the platform gets the placement system into position, two of a leveling unit 16 can take up the weight to stabilize the frame, if the platform is not large enough to be capable. Alternatively, the levelers 16 can be used, in cooperation with arm 59, to position the frame. The arm can have supports and restraints for the hose 80, as required.

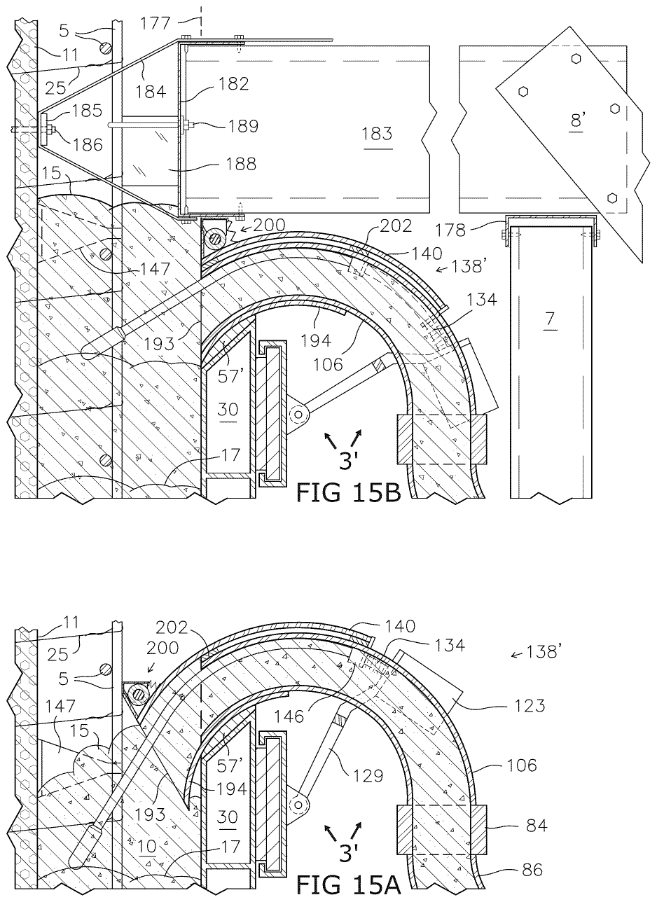

A number of the strut 8′ can be prepositioned to brace the wall backing plane, and the frame 1″ can be made to fit beneath them. As a placement system 3″ needs vertical clearance in switching from side to side during concrete placement (described in FIGS. 15, 16, and 17) the braces generally need to be outside of the frame locations, for this embodiment. For another embodiment, the braces can be within the frame location. The ledger 178 of FIG. 2 can be pre-positioned if it is set close enough to the wall that the pipe 53 will clear it.

A number of an RFID tag 127 can be placed onto, or built into, critical prepositioned elements such as member 13 or window opening frames, etc. An RFID reader 97 is shown on the side of guide 32 for visibility in this drawing; normally it would be at a location facing the wall. This allows the boundaries of concrete placement and obstructions to be determined electronically. The relative positioning information appropriately directs actions of concrete placement (motions and pump control), vibrator deployment, for purposes of avoiding contact with in-place elements and terminating concrete placement. RFID tags can also be placed onto locations defining an element that is cast into concrete, such as a stub-out for a water pipe, for subsequent location of the element. RFID tags can be placed on obstructions to allow electronic determination of a tool path that avoids obstruction.

Positioning systems such as GPS system or laser based system can be employed. This example shows a laser sending device 173 which is positioned to define the plane of the wall. This can be one, as presently utilized by the construction industry, that sends a plane of laser light from a rotating mirror, aligned for the wall plane. A number of a laser receiver 171 can be attached to the frame, with correctional information sent to the mobile platform, so that it can position or re-position the frame.

The mobile platform can be an articulating robot on tracks, so as to maintain positional reference, in order to follow a path defined by a digital model, as is practiced now with 3D printing methods. The present method is effectively a 2D printing control system having depth control of the printing plane, sometimes referred to as “2.5D Printing.”

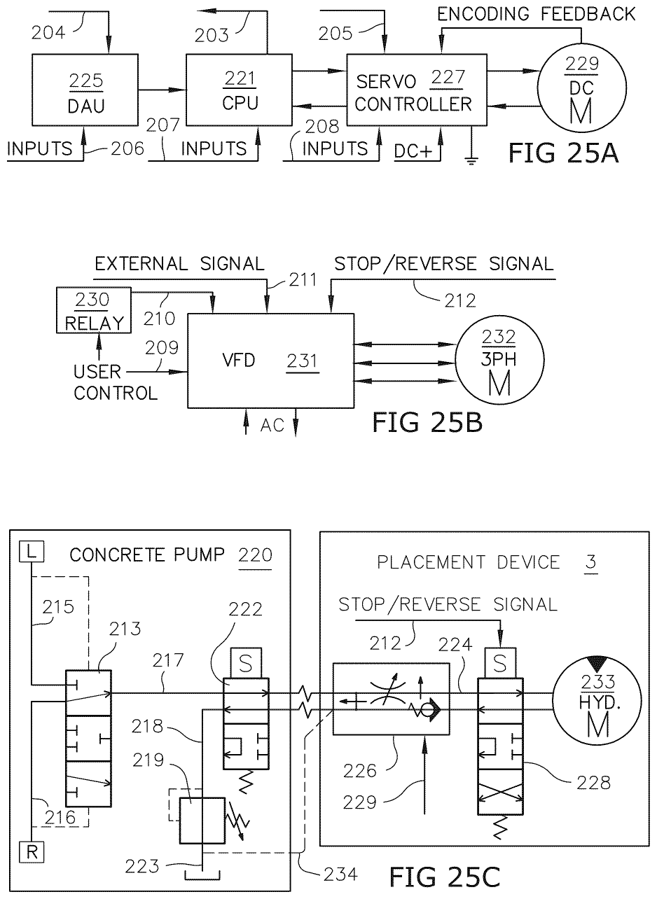

For system automation of the placement system where its placement rate is based upon a concrete volume flow rate 235 pumped from a concrete pump 220, where the concrete pump rate may or may not be able to provide a precisely controllable concrete flow rate. So the placement rate is adjusted to match the concrete pump. The details are provided at the description of FIG. 25A.

### FIG. 3A

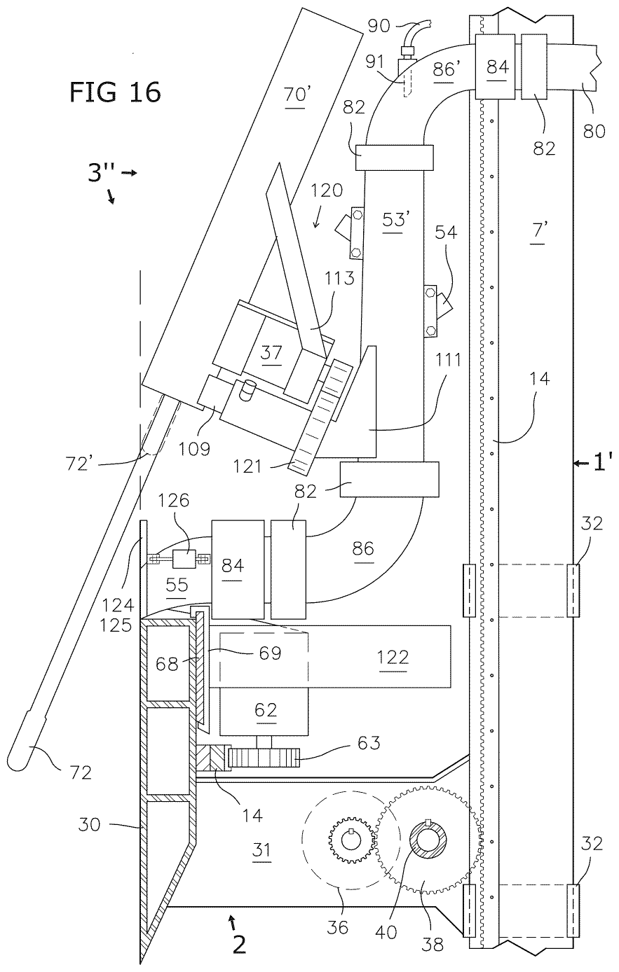

Concrete placement device 3″ is designed for continuous placement with vibrational consolidation while moving, and has a preferred path of travel where each placement pass begins at an end of beam 30, and terminates mid beam, with a subsequent pass that begins at the opposite end of the beam, and terminates at the same location. Then the beam lifts a predetermined amount, to allow device 3″ to begin a subsequent placement at the first end, above the previous. The attachment of a vibrator 70′ to a swivel pipe 53 is shown in FIG. 16.

Placement device 3″ utilizes two of a swivel joint 84, each with a horizontal or inclined rotational axis, to allow concrete placement on either side of vertical beams 7, and also to allow low-profile placement. The hose 80 can be managed with a hose support system 91′ that uses a solid travel bar 61 supported by two of a brace 64, each attached to the top of the corresponding vertical guide 32. An adjustable sling 107 secures the hose, and with two of a stop 45, can direct the device 3″ swivel action, so that when the roller carrying the sling hits a stop, the continued travel of the lower end of the swivel pipe causes it to slope in the opposite direction. When the lowest profile of device 3″ is required, the sling most conveniently has an actuator that extends the sling length at those conditions, such as when the concrete placement is at the top of the wall. This relative positioning can be determined with the RFID system, or a digital model, etc.

A strut 65 represents a physical tie to the wall backing plane, and can have an attachment to that plane by the means disclosed further below, or other conventional means. The struts provide a means to physically reference the frame to the backing plane, in order to position the frame relative to the backing plane, or to hold the frame into a position as was determined by other means. If the backing plane is braced at the proper position, then utilizing the struts will lower the forces to the other supporting elements of the frame, allowing for a lighter system.

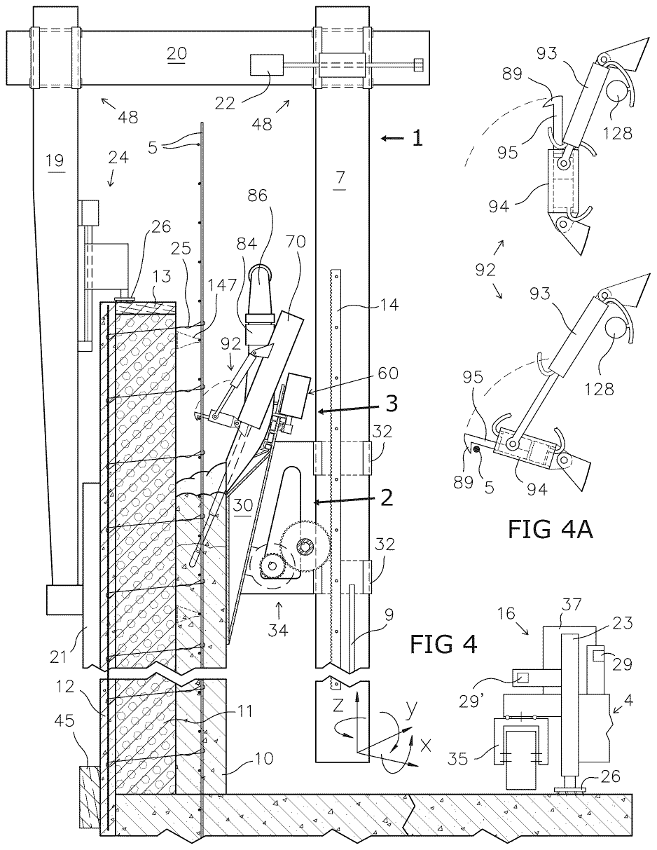

FIG. 4

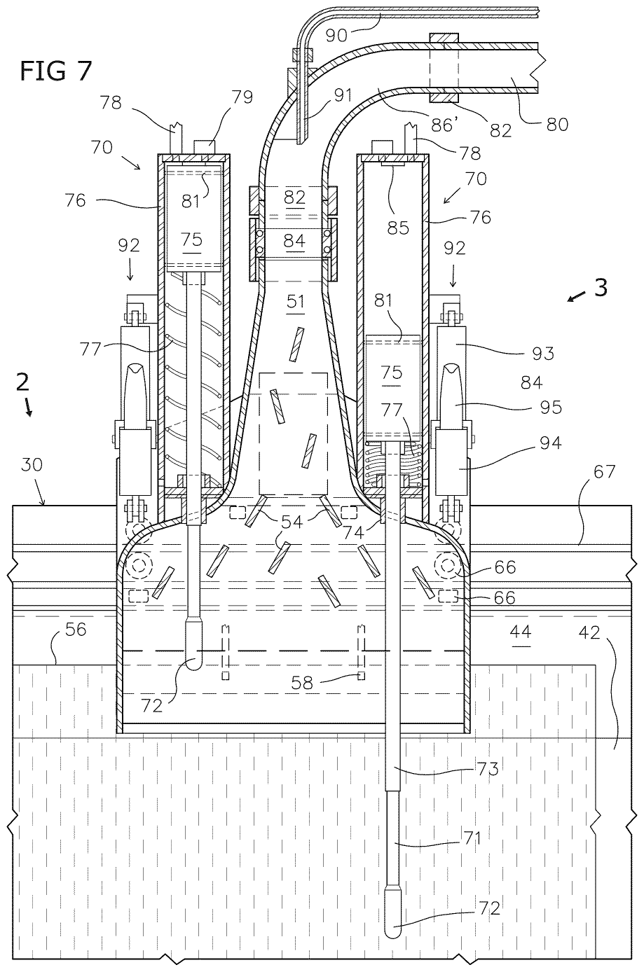

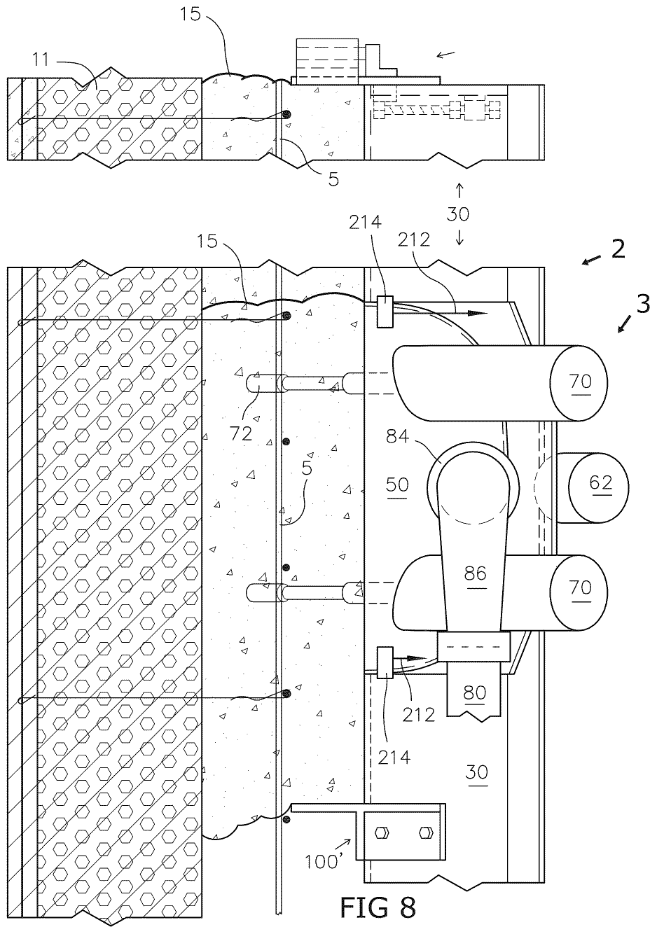

FIGS. 4 through 6 are very similar, so that many labeled elements may be discussed via subsequent figures. It is helpful to have all of these (plus FIGS. 7 and 8) within view for the description of any of them.

FIG. 4 shows frame 1 providing bracing for the top and also mid-portion of a backing plane, which in this case is of rigid foam panels 11 having stucco cladding 12 applied, where the stucco reinforcing wire is tied, with a series of the tie 25, to the reinforcing 5 of the concrete 10. Clamping to secure the top of the wall is provided by a clamping linear actuator 22 which presses a spiked foot 26 into an alignment member 13 that is affixed to the top of the foam panels. Member 13 is similar to a “top plate” of a wood-framed wall. Bracing at mid-height of the wall can be provided by a planar support pad 21, attached to a bracing arm 19. The connection of arm 19 to beam 20, and that connection to vertical beam 7, can be made by using adjustable, sliding connections, with that adjustment controlled by a linear actuator 22, or the like.

To allow for multi-story concrete wall construction, clearance for reinforcing 5 to extend above the present concrete placement can be provided for by locating beam 20 high enough. This higher position, and the presence of the mid-height bracing, increase bending forces onto all these members. To reduce these forces and allow these members to be lighter, a dynamic tie 92 is employed. This device temporarily hooks onto reinforcing steel 5 while device 3 is placing concrete, and in this case, not moving. As the reinforcing 5 is already tied to the stucco wire (as it should be anyway to tie the stucco to the wall), these ties transfer the tension load into the stucco, which bears that load against the foam. The reinforcing can also be secured in plane with a rebar chair 147. The strength (wire and connection) and quantity of the ties must be sufficient for the fluid load of the concrete volume being vibrated. If a given placement being vibrated is 8 inches high, the fluid pressure will range from 0 to 100 pcf, averaging 50 pcf. If a 16-inch width is being vibrated, the total force is 50 psf over a 0.89 square foot area, which is 44.5 lbs. Under the international building code, stucco ties are normally placed at 7 inches on center vertically (6 inches in high seismic areas), and at 16 inches on center horizontally (corresponding to normal stud spacing), averaging about 1.5 ties per square foot. Assuming 2 ties taking the total force of 44.5 lbs, which is 22.3 lbs per tie. With a factor of overstrength of 3, each tie should be designed for about a 67 lb load, to accept this proposed loading scheme. The dynamic tie is described more in FIG. 4A.

The frame 1 can be any system that provides positional control of vertical beam in x, y, and z axes, both linear and rotational, and also provides a means of holding that position given loadings imposed primarily by the vibrational placement of concrete. If the wall backing plane (in this case foam with stucco cladding) is itself sufficiently stable or braced for concrete placement, then frame 1 does not need to brace that (eliminating elements 19, 20, and 21), and needs only to position the slip form system 2 for concrete placement.

The leveling unit 16 shown here includes a pivot wheel 35, which can be motorized. A laser receiver 29′ can indicate where the to position the base frame 4, or multiple laser receivers for both x and y axes. Then linear actuator 23, powered by motor 37, can lift the base by pushing spiked foot 26 down, where laser receiver 29, can find a predetermined elevation for the base. The spiked foot has spikes of hardened high-carbon steel, or the like, so that it anchors the base for translational loads of concrete placement.

The initial lift of any concrete placement sequence begins at the bottom edge of the slip form beam 30, where it is in contact with an initial horizontal surface. This initial concrete placement is exceptionally deeper/taller than a typical lift—that utilizes only the upper portion of the slip form. The reach of vibrational systems disclosed, meant for typical lifts, can be exceeded at the initial placement, so that it can be more practical to consolidate the taller initial lift with a manually operated vibrator. Of course, the vibrating systems of the following disclosures can be designed to extend to essentially the bottom of the slip form, so that the initial placement can be vibrationally consolidated entirely by automation. Then, at a typical lift, this additional reach of vibration systems would need to be withheld; if not, the already-placed concrete (below the confining action of the slip form) could be caused to “bulge outward”. In some cases, particularly where the wall backing plane is just rigid foam, a continuous stop block 45 may be required to allow the backing plane to accept the relatively minor form pressure of this method. The initially higher form pressure from the taller initial placement may justify this.

### FIG. 4A

Two of a dynamic tie 92 are shown in the vertical, unengaged position. The dynamic tie serves the purpose of accepting fluid-pressure force from concrete placement so that the frame system 1 and its connections can be minimized, and also to that the backing element of the wall can be minimized structurally. And to also move clear of the plane of concrete placement as necessary to avoid pre-situated objects in that plane. Further, the dynamic tie follows a path of motion that allows for success in grappling a horizontal reinforcing bar when the precise vertical location is not known. If a reinforcing mesh has a vertical spacing of a distance X, then the corresponding device must be given a motion that will provide successful grappling of a rebar over at least the distance X, so that one bar will always be in a location that allows grappling by the device.

The dynamic tie 92 consists of two interacting linear actuators. In this example both are dual-acting pneumatic cylinders, in that they are connected to an air manifold system having a pneumatic line connected to both ends of each cylinder, with each of these lines providing controlled pneumatic pressure to the cylinder, and also a means to release air from that end of the cylinder (or this can be accomplished with a separate solenoid-controlled valve).

Cylinder 93 controls the pivot of the tie. When it is pressurized to extend, cylinder 94 pivots downward. This force can be very low, in that a stem 95 only needs to make contact with a reinforcing element 5. This can be accomplished with as little as a 10 lb force, so (ignoring friction) a cylinder with 1 square inch area needs only 10 psi—with 20 psi being sufficient in any case. Cylinder 94 is normally extended, and will retract after stem 95 has made contact. This can be determined by measurement with pressure gauge 87, which will indicate a pressure rise to cylinder 93 when stem 95 makes contact. This pressure rise can trigger air pressure to retract cylinder 94, either by a pneumatically-activated solenoid, or a switch that at a pressure limit, switches that air flow to cylinder 94 to begin its retraction. This engages a hook 89 onto reinforcing bar 5, holding system 3—connected to system 2—to the wall backing plane. This pull should be limited to avoid damage to reinforcing 5 etc, and so this also requires only low pressure. If cylinder 94 has 3 square inches, a 20 psi air pressure will hold 60 lbs. At this pressure, a pair of dynamic ties will hold 120 lbs, exceeding the expected form pressure from each vibrational placement of concrete at the placement size indicated.

The extension of cylinder 93, combined with the radius of the arc of motion of the hook 89 (with cylinder 94 extended), needs to intersect the plane of reinforcement over a distance of at least the spacing of horizontal bars, so that a bar 5 can be engaged without requiring any coordination between this device and reinforcing placement. Interference from the dynamic tie aligning with a vertical bar, and so not able to grapple a horizontal bar, is minimized by the hook having a taper to its tip that is similar to a bird's beak (visible on FIG. 7), and by allowing enough play in the cylinder pivot connections so that the hook can shift after such an impact. If the pair of dynamic ties are spaced at a distance that is not a multiple of the vertical bar spacing, then it is impossible for both hooks to hit vertical bars at a given use of the system. Rather than utilizing a hook to attach to reinforcing, any of the magnetic tie designs, disclosed below, can be used.

### FIG. 5

This section view shows a backing of foam 11 without any cladding. It has an optional alignment member 13 on top, and is backed with a vertical beam 7′ that can be a conventional wood framing member staked into place. It is braced by a strut 8′, which can also be a conventional wood framing member, conventionally fastened to member 7′ and also staked into place at its lower end. This means of bracing is one option to provide the backing place to accept concrete form pressure—which is minimal with this method—and to avoid the need for the frame 6 and/or beams 20 and/or bracing arm 18 or 19 and/or planar support pad 21 to make a free standing wall. The disadvantage of the conventional bracing placed on the wall exterior is that it becomes impractical for multistory construction. Accordingly, any of the other means of bracing disclosed will work with this plain panel of rigid foam for multistory construction.

A pre-situated tie 25′ is shown—one that does not need to tie to the reinforcing 5, as it is much easier to install any such necessary stucco or masonry veneer ties before concrete is cast, rather than drilling and fastening the many connections later, into hardened concrete. These ties can be any previously disclosed, and their installation can be automated or mechanical per previous disclosures.

Nozzle 50 houses the business end of an integral actuating vibrator 70, so that vibrator head 72 can house within nozzle 50 when retracted. Typically the head 72 can be vibrating as it is extended, so assisting discharge of concrete from the nozzle, and can also extend into concrete, preferably vibrating a boundary between concrete placements 17, so that the currently-placed concrete is consolidated with that previously placed. Three extended positions of head 72 are shown. The position that is through the plane of reinforcing 5 is the linear extension of the vibrator with no horizontal motion of placement device 3. As it can be preferable to not stop that motion for concrete placement, the head 72 will tend to swing somewhat to the other positions shown that are not though the reinforcing. More detail is provided further on.

The vertical travel system 34 consists of a vertical drive motor 36 (foreground), which can be a stepper or servo motor, rotating pinion gear 38, which engages gear rack 14. Motor controllers are typically not shown, and are described more thoroughly at FIG. 25. A drive shaft 40 is to transfer the same rotational motion to a matching rack and pinion system (foreground). Further gear reduction than that shown here (for simplicity) can be warranted. Two of a vertical guide 32 fit about vertical beam 7, with sliding bearings of suitable low friction material. Vertical beam can be a steel tube of 6″×2″× 3/16″, and sliding bearings can be Teflon or UHMW or oil-filled nylon. Each guide 32 should be located a sufficient vertical distance from the other to avoid any detrimental play in motion, preferably at least the distance that the slip form beam 30 is tall; a greater distance, if possible, improves performance. The positioning by this system utilizes two of a beam support 31 to locate and support beam 30. It is intentional that supports 31 are located away from the beam ends, in order to lower the span—allowing a lighter beam, and also allowing beam to extend beyond all elements of frame 1, so that concrete can be placed right up to an inside corner of a building. This also allows a smaller overall frame size.

The concrete being placed 15 coming out of the nozzle 50 will generally settle to a lower height from vibration, shown by the next line below. It is not critical to control the resulting height of concrete carefully, as more concrete will come over it and get mutually consolidated. Where a subsequent story of concrete is to be placed, this potential cold joint can be left uneven or trimmed to be straight as desired.

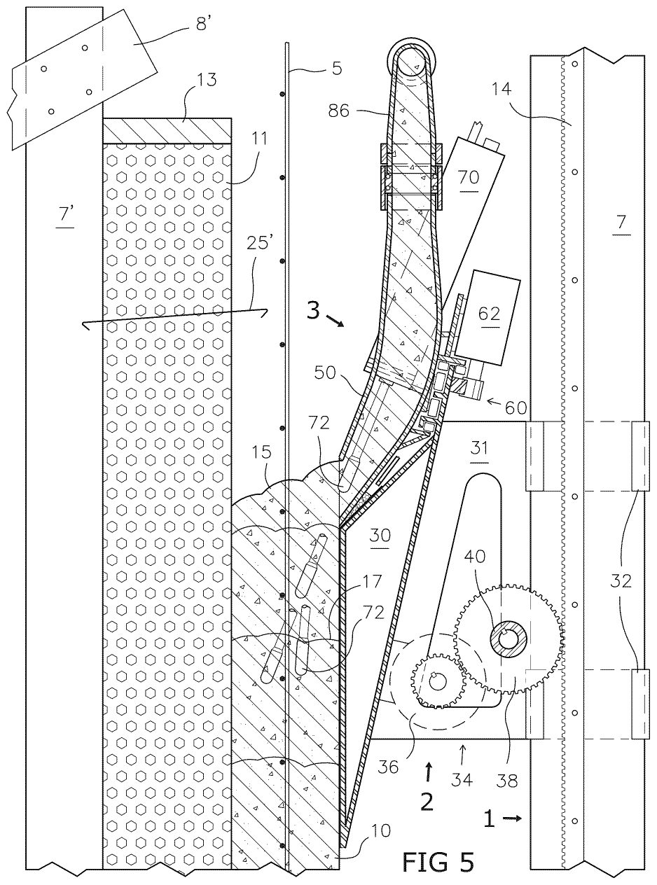

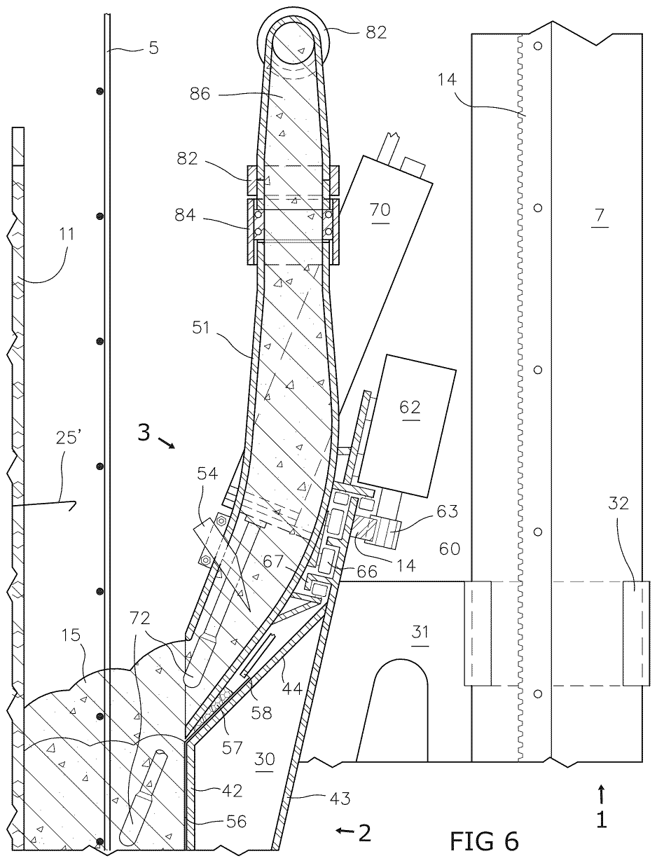

### FIG. 6

This zoomed-in view omits most of the thickness of the foam panel 11 backing. This shows a nozzle 51 that includes one or more of a mixing vane 54, so that intermixing with a modifying admixture can occur within the nozzle. An elbow 86, which in this case increases in size upon connecting with a coupling 82 to a swivel 84. Horizontal motion of device 3 is controlled by motor 62, which can be a stepper or servo motor, driving pinion gear 63 which engages gear rack 14. Further gear reduction than that shown here (for simplicity) can be warranted. Any other suitable type of traction engagement system can be used, such as friction rollers of rubber. These can be urethane drive wheels, of Shore A durometer between 20 and 80. This can also be the case for the vertical drive system 34, though these traction loads are higher, in taking the combined weight of systems 2 and 3, plus the concrete in the hose. So the normal force required for traction will have to be very high.

Horizontal guidance is provided by a set of rollers, such as a roller bearing 66, that is guided by a guide plate 67. The arrangement of rollers and guides can vary from that shown, providing all loads presented to system 3 are addressed. The guides are elements of the beam 30 (system 2) and go the entire length of it, or as motion of device 3 requires, as does the gear rack 14. The guide plates can be of ¼″ thick aluminum, if the beam is of the same material.

In this example the beam 30 is triangular in section, where the back plate 43, the face plate 42, and the sloped top plate 44 can all be of ¼″ aluminum. One or more of an irrigation nozzle 58 is fed with a supply of water so that it drips onto a flow control sponge 57. This system provides lubricating water to a replaceable fabric 56, which is there to hold sufficient water to release bonding with the concrete, and provide a smoother surface as the form face moves. As the water supply is located with the nozzle, it will irrigate primarily after concrete has just been placed. It can be preferable to omit the sponge and provide timed control of the nozzle 58, so that it sprays only right after a concrete placement has been made. The water volume should be that sufficient to keep fabric 56 soaked sufficiently to provide lubrication, but to not negatively affect concrete. As the modified concrete is low in water, this is not a significant concern.

### FIG. 7

The mixing nozzle 51 shows several of the mixing vanes 54, which also be oriented to help distribute concrete out to the broad shoulders of the mixing nozzle. The purpose of this nozzle shape is to manipulate the cross section of concrete to have a rectangular shape with a slender aspect ratio, so that the concrete being placed conforms substantially with the space into which it will be placed. The internal vanes 54 will allow passage of concrete because of the expanding cross section in that portion of nozzle 51. And if the aspect ratio of the concrete is more slender than the void into which it will be placed—in that the void is typically is split by a plane of reinforcing—the placement becomes easier to consolidate when the nozzle is held stationary. This minimizes the energy required to vibrationally consolidate the concrete, allowing for shorter vibration times, and so faster placement of concrete.

If the nozzle is moving during placement of concrete, there is less importance in having a slender aspect ratio. A square or low-aspect rectangular nozzle orifice is very beneficial relative to a circular orifice, in terms of filling a rectangular void more efficiently, and in reducing the vibrational energy required for effective consolidation. In trial construction projects this concrete consolidation has proven to be the critical path to concrete placement rate—rather than the rheology of the concrete holding a vertical surface—so that improving efficiency of the consolidation process, speeds up the entire concrete placement process. Speed of placement is critical to the economic viability of the method, in that rapid placement allows practical use of delivered ready-mix concrete. Viability can be defined to be where a typical concrete delivery can be consumed in under about an hour, and preferably in less than a half-hour. Most other methods of digitally-controlled concrete placement are not capable of a placement rate that justifies concrete delivery, and so must use small batches of concrete or mortar, batched onsite, at a much greater expense (as measured when all cost factors are considered).

A modified elbow 86′ contains an injection quill 91, which is fed modifying admixture through line 90. This is to exploit the curvature of the elbow to allow the injection point to be in a location that is more in the center of concrete flow. Elbow 86′ can have a larger exit diameter than entrance diameter (a reducer in reverse), so that blockages can be avoided, even with the presence of an injector projecting into it. Quill 91 can be braced by a gusset plate downstream.

One integral actuating vibrator 70 is shown extended while another is retracted, just for illustrative purposed. This would not normally be the case, as both would engage at the same time. The retracted vibrator has had the air supply 78 shut off, and as the motor 75 is air powered, it will bleed pressure out thought vents at the bottom of the cylinder (not shown), or air can bleed out by the solenoid valve 79. In either case, this allows the spring 77 to push the motor 75 back to the top. At least one of a ring seal 81, such as a lubricated o-ring set into a groove in the motor, allows the motor itself to act as a piston. When air pressure is reengaged via line 78, motor is activated and pushed. As air flow is sufficient to run the air motor and also have resulting pressure in cylinder 76 to compress spring 77, then vibrator will extend. The motor is running this entire time (that the effective air pressure is above a minimum that turns the motor). And when it is time for the vibrator to retract, the pressure is reduced to an amount that allows the spring to push the motor back up, but where the motor is still rotating. This allows the vibrator to continue to vibrate as it is withdrawn. A pad 85 provides a suitable stopping place for the motor.

The vibrators shafts have the common rotational cable that rotates an eccentric weight at the head 72. These shafts are divided into two parts, a solid pipe section 73 and a flexible section 71. The solid shaft is needed to allow a sealable opening though the nozzle casing at shaft seal 74, as the vibrator is extended and retracted. The seal only needs to be good enough to prevent too much cement paste from leaving nozzle at this low-pressure point of the line, so a precise metal to metal fit of a few thousands of an inch gap is OK. Also, the vibrator needs to direct the vibrating head to a known location, so the majority, or a significant portion, of the shaft needs to be rigid for that purpose. The flexible portion of the shaft 71 can be just like a normal internal vibrator would have, and can have a normal threaded fit into the rigid portion. The flexible portion is optional, and serves to reduce vibration transmission back to the vibrator motor 75, cylinder 76, and connection to the nozzle 51. If vibration is intended while the nozzle is in motion, then the shaft and cylinder connection needs to be designed for the significant side loading. The flexible portion of the shaft reduces this load.

A number of the roller bearings 66 attached to the nozzle can be seen, guided by tracks 67 aligned with the beam 30. These are typically spread as far from each other as the nozzle size allows. The irrigation nozzles 58 provide lubricating water for the (optional) replaceable fabric 56, which is a weave or mesh, of an abrasion resistant material, such as polypropylene, nylon, fiberglass, Kevlar, etc, attached with a contact cement.

### FIG. 8

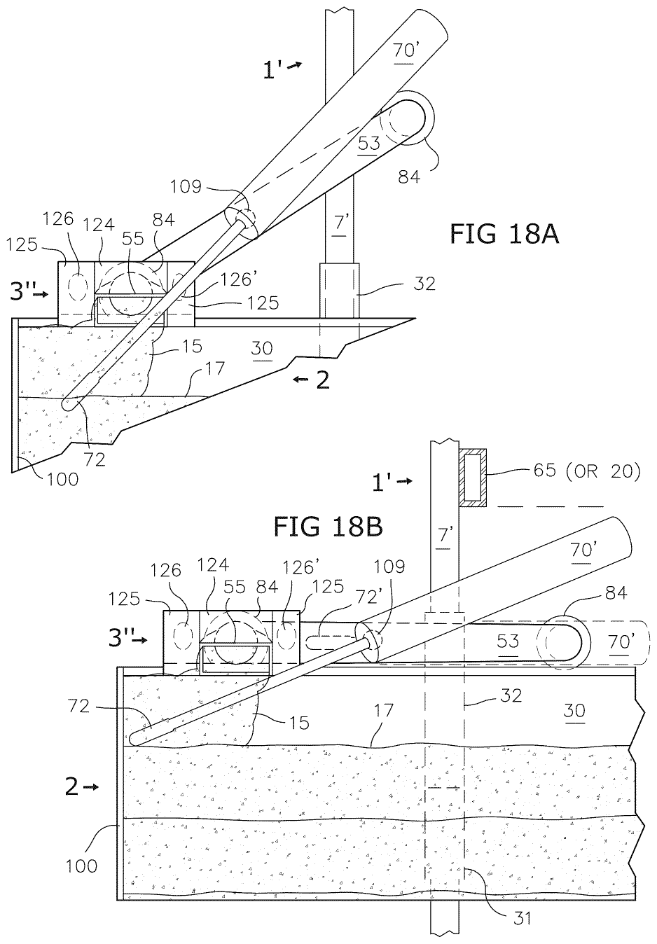

A top view helps orientation of device 3 elements, which in this case the nozzle 50 houses two of the integral actuating vibrator in the extended position, and locations of the vibrator's heads 72. A leading edge of concrete is shown being placed 15. The swivel 84 allows elbow 86 to pivot both ways for motion driven by motor 62 along beam 30. The end of beam 30 shows the control joint creator 100, creating a straight control joint for concrete on the visible side of the reinforcing 5, whereas behind the reinforcing the concrete being placed 15 will billow out according to the rheology and intensity of vibration applied there. Subsequent placement of concrete will normally begin immediately on the other side of the control joint. Device 100 is described thoroughly at FIG. 18.

An intermediate control joint creator 100′ can be placed at any intermediate location on slip form beam 30, where an end of the beam cannot be positioned for that control joint. Attachment to beam can be by machine screw fasteners of controllable magnets (disclosed further on). A proximity switch 214 can be at either side or both sides of device 3. This can be a metal detector proximity switch, or a mechanical switch, which is tripped whenever device 3 becomes adjacent to device 100 or 100′ or other fixture that establishes the horizontal extend of the present concrete placement. The switch is powered, so that upon contact with such a fixture, switch 214 sends out a signal 212 to the system controlling the device 3 motion, where the system stops the device motion, disclosed further at FIGS. 25B and 25C. After this signal, when the device continues motion, it will be in the opposite direction, until the switch on the opposite side of device 3 is tripped.

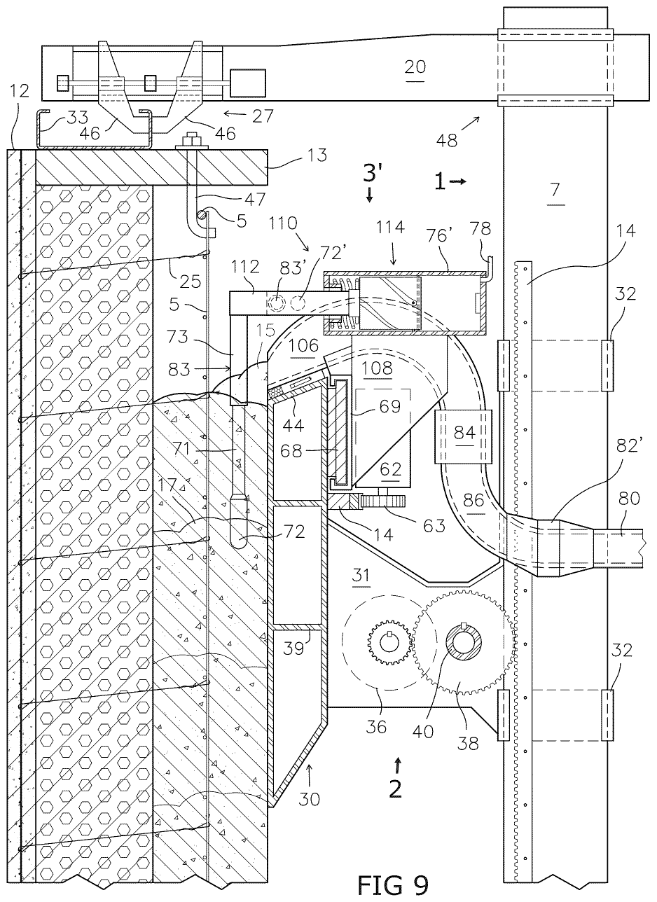

### FIG. 9

FIGS. 9, 10 and 11 show different views of same or similar elements, so it is most helpful to have all three drawings in view for this discussion. FIGS. 12, 13 and 14 are different embodiments.

A low-profile nozzle 106 is designed to place concrete over a form member (such as beam 30) while having the lowest vertical clearance possible. This is so that the wall brace elements, such as beam 20, can be close to the top of the wall, reducing member forces and allowing a lighter overall structure. Also, this allows for installation of stationary bracing of the wall backing plane to be in place, such as brace strut elements sloped down to the floor, or the pre-installation of some upper-floor or roof framing members. This design avoids the need for wall bracing elements to be part of frame 1, where the wall bracing on the concrete-placement-side of the wall is necessary—such as for multi-story construction. Because this embodiment of the device 3′ is needed to travel horizontally past vertical beam 7 (both ways), nozzle 106 curves back down tightly as practical, so that swivel 84 has a vertically oriented axis, so that hose 80 and coupling 82′ (which is coupling 82 without an external clasp and with fairings to minimize tendencies to interfere with vertical beam 7) will clear vertical beam 7.

To allow the low-profile geometry, a rotating-actuating vibrator 110, is designed to allow low-profile deployment of the vibration head at appropriate depth into concrete, and retraction clear of the plane of concrete placement (shown in FIG. 10)—in particular to clear presituated objects, such as the alignment member 13, or similarly, presituated elements such as window frames (not shown). To accomplish this, a horizontal cylinder 76′, provides a thrust-twist rotational system; where a torsionally-substantial portion of is shaft, or “torsion shaft” 112, ends in a 90 degree turn to a lighter portion of rigid shaft 73, with a worm gear at the turn to transfer internal cable rotation, to allow pivotal action of the shaft end portion 83, The worm gear can be the same as those utilized with portable worn drive saws, which can include a flexible portion of the shaft 71, the same as for vibrator 70. This system plunges the vibrating head 72 into the concrete by rotation, and preferably at a maximum depth that reaches into the previous placement of concrete. Shown hidden behind torsion shaft 112 is 83′, which is the same as 83, but in the retracted position. Next to it is shown the vibrating head 72′, of the identical-mirrored rotating actuating vibrator This vibrating system is shown more clearly on FIG. 10.

This concrete placement device 3′ receives horizontal guidance from a guide rail 68 that extends the length of beam 30′. Rail 68 can be of a low-friction material such as UHMW. Device 3′ utilizes a channel 69, such as of 3/16″ steel or ⅜″ aluminum, which preferably extends the width of nozzle 106, to engage rail 68. A connecting plate 108, each side of nozzle, or the like, connects nozzle to vibrators and channel, and supports and houses motor 62. Pinion gear 63 drives device 3′ using rack gear 14, or another frictional drive control system can be used.

The components of system 2 for vertical drive can be the same as previously disclosed. Beam 30′ is a box section with one or more of a web stiffener 39. The bottom plate also slopes toward the wall, so that that bottom edge is more easily made to seal at the starting plane (floor) which may not be level.

An aligning/clamping linear actuator 27 can be utilized to position frame 1 relative to wall plane backing. In this example, a temporary channel guide member 33, which can be of a relatively heavy (such as 10 or 12 gage) light-gage-steel framing member, which can be splined, as may be required, by a matching channel member. This is pre-positioned to establish wall planes, and can be rigid enough a guide (from adjacent perpendicular walls) so that it can be determinant of the location of frame 1. Positioning frame 1 can essentially follow guide 33, and then determine/measure vertical, and then hold that position, in order to define the plane of the wall. This reduces the necessary complexity of frame 1. Actuator 27 has two of a clamping element 46, each attached to a ball screw of opposite thread direction, so that a servo or stepper motor action will clamp or unclamp. This system can locate where needed to define a given wall plane, and adjustment can be made with adjustment at the intersection between vertical beam 7 and beam 20 (that lineal actuator not shown). As actuator 27 clamps onto channel, rather than pushing down, less moment strength is required at this joint. And as beam 20 is as close to the wall top as possible (because of the low-profile nozzle), then all loads to frame 1 are reduced. If the controllable magnetic ties are also used, then the loads to frame 1 are minimized, allowing the lightest geometry-definition-frame device possible.

Alignment member 13 shown here is one that caps the entire finished wall, such as where a roof will be attached, and anchor 47 can be used for that attachment purpose. Member 13 is optional, providing guide 33 has sufficient attachment to the backing plane, whatever it may be. Attachment to rigid foam panels can be effected by a combination of adhesive and dowels. For multi-story walls, member 13 between floors can be omitted, or built into the wall within the same plane as the foam panels.

### FIG. 10

A top view of the low-profile nozzle 106 shows both rotational actuating vibrators cut-away, with one extended and one retracted. Typically, they would both generally be in the same position during concrete placement, that is, both extended while the device 3′ is placing concrete and mostly not moving, and then both retracted before moving to the next placement location. The torsional actuation of the embedded portions would be difficult to move against relatively-moving concrete; though this is possible if a heavier mechanism is employed.

The mechanism 110 shown uses air pressure for vibrator actuation and motor operation, as was shown for vibrator system 70 of FIG. 7; and it operates on the same idea of using air pressure/flow for both actuation and pneumatically-powered vibration, and in reversing that actuation by spring 77 power. The primary difference is that this mechanism has a number of a stud 90 that engages a spiral groove 89. When sufficient air pressure and volume is applied, to move the motor/piston, rotation is forced by a number of the pin-groove engagements. A section view of the vibrator (upper right corner) shows the engagement of stud 90 engaging spiral groove 97, where a number of the grooves are cut into a twist sleeve 96, which tightly encases the vibrator motor 75 (and the two can attach mechanically). The studs should be of high-carbon hardened steel or the like, such as of ⅜″ diameter rod—or square stock aligned with the groove. Stud and can be a press-fit though the pneumatic cylinder wall. The sleeve 96 can be mild steel. This is mechanically analogous to a “Yankee” screwdriver tool, though the present system need only effect a single 90-degree+/−rotation; and then reverse it, when the air pressure and volume are reduced enough to allow the spring 77 to retract the motor/piston. Importantly, the piston seal 81 needs to be at a location where it avoids both the studs and the grooves throughout out the mechanism motion.

Each vibrator leg 83 in the retracted position must clear the face of concrete, if alignment members, window jambs, etc are pre-situated up to that plane. So, both legs must have an available location to park on top of the nozzle. The pair must be offset horizontally or vertically to allow this, and the timing of pneumatic action may require a delay for the leg parked furthest from the wall, to avoid physical interference between them.

Rather than the pneumatically driven, any of the actuating vibrators disclosed can be electrically powered, such as with solenoid actuators, or hydraulic.

This top view shows the motion of nozzle 106 guided by channel 89 along track 68, powered by motor 62 engaging gear rack 14. When the nozzle is between both of the vertical beam 7, hose 80 and coupling 82′ can extend directly away from the wall. A dashed nozzle 106′ is shown to indicates its position at one end of beam 30′ (control joint creator 100 not shown), where coupling 82 (and hose 80) must rotate, via swivel 84, to clear vertical beam 7, in order for nozzle to extend beyond it. Generally, the end of beam will extend beyond a control joint 41, which was the edge of the previous wall concrete placement, and can contain a separation strip (99 of FIG. 1).

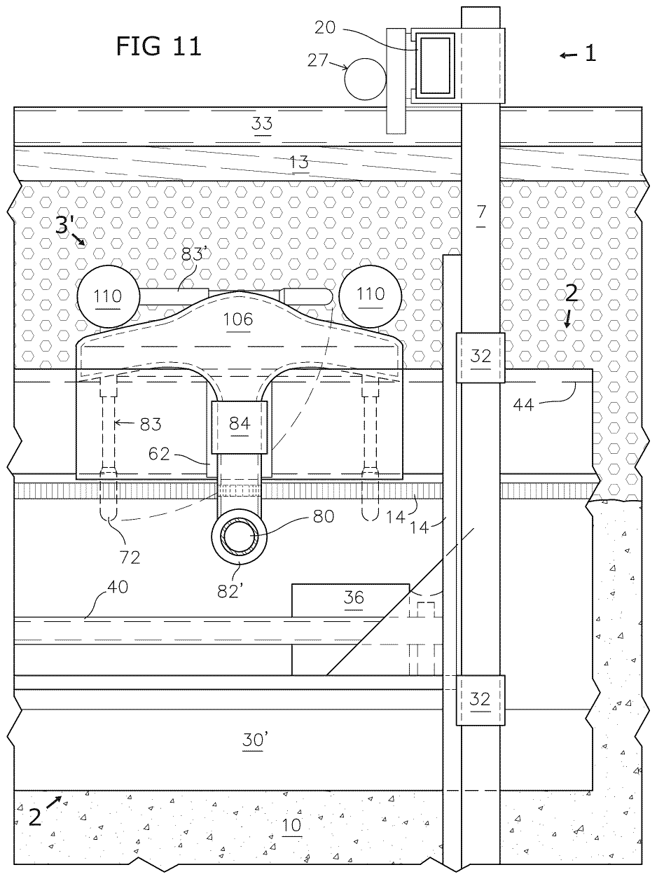

### FIG. 11

This shows how the low-profile system looks from the back, with most element identifiable from previous disclosure. The path of rotation of the left vibrator 110 is shown dashed, with leg 83 shown down, and as 83′ when pivoted up.

The low-profile nozzle 106 slopes down to both edges, but has a rectangular opening of high aspect ratio, with the top edge shown as a prominent dashed line over its full width, and the bottom edge hidden behind the beam 30′. In order for the nozzle opening to reach the underside of member 13 (in this case), the top of the nozzle 106 body and the vibrators 110 must be able to clear under the overhead beam 20. It may be necessary to place spacers under guide member 33 where it fastens to member 13 to provide the clearance.

### FIG. 12

This pair of images, 12A and 12B, shows the low-profile nozzle 106, having one or more of a pivoting-plunging vibrator 136: A, in the retracted position; and B, in the extended position. Relevant FIG. 9 disclosure is generally not repeated here. This example shows concrete being placed against an excavated surface, as would commonly be practices with shotcrete.

An actuating cylinder 135 engages a pivot arm 129, in order to plunge the vibrator head 72 into concrete. A vertical plate 28 connects the cylinder reaction to the guide channel 69 and the nozzle 106. The actuating cylinder is preferably double-acting, and can be pneumatic. A vibrator motor 123 is attached with a bracket to arm 129. The vibrator flexible shaft 71, which can be one conventional for concrete vibrators, is inserted within an inner pipe 130 (a first curved pipe), that pipe being inserted within an outer pipe 131 (a second curved pipe), which is affixed to the nozzle 106, or the like. These pipes are both curved hollow cylinders. They can be of conventional pipe material, or rigid tubing, formed into their curved length, or each can be cast into that shape, of composite or metal material. Both pipes provide an arc corresponding closely enough to the rotation of arm 129, so that the inner pipe can translate along that arc within the outer pipe, and the combination serves to guide the inner pipe beyond the extent of the outer. This allows the extended portion of the inner pipe to guide the flexible shaft beyond the extent of the outer pipe, in this case, creating a system that can remain clear to one side of the plane of the concrete wall, yet provide internal vibration with a flexible shaft that is guided downward.

To allow the head 72 to stay clear of reinforcing 5 during a plunge, a preferable sequence of the plunging action is to create conditions where the inner pipe translates within the outer pipe generally before the flexible shaft translates within the inner pipe, and during retraction to have the opposite sequence to occur. For this, a spring 134 is wound about the flexible shaft to provide pressure on the end of the inner pipe (when the arm makes a plunging motion), and in combination with compatible frictional conditions, moving the inner pipe before the shaft moves within the inner pipe. As the inner pipe reaches the end of its motion because of engaging the end of the outer pipe, the spring compresses as the shaft translates within the inner pipe. A preferred amount of that translation is where the vibrator head engages the boundary 17, or has consolidation influence on the bonding between concrete placements. An inner seal 132 prevents the majority of cement on the shaft from entering the inner pipe. The seal can be of abrasion resistant flexible material, such as polyurethane, EPDM, nitrile, etc, and can be a cylindrical shape set into a recess, or with keepers, inside of the inner pipe. Similarly, an outer seal 133 can be made to fit between the pipes.

These seals are not essential to the operation of the device; their purpose is to minimize clean up; except that the inner seal acts as a stop for seating the head 72 to retract the inner pipe (when arm 127 retracts the vibrator motor), and a solid-material stop can instead be used for this purpose. Alternatively, the inner seal can be replaced with a bellows boot that allows the relative motion of the shaft while protecting it from contact with concrete, and can compress between the retracted head and the outer pipe.

The outer pipe is shown welded to a face plate 124, so that head 72 plunges though the face plate and retracts behind it. This is not necessary in that the face plate may not be present, or the vibrator shaft can go over it.

The challenges with this specific design is that the vibrator motor 123 must clear the vertical beam 7 over its motion, and both that and the cylinder 135 (and their connections) must clear the beam support 31, where one can see the lower attachment of the cylinder is to a brace that is just clear of the support 31. Also in this case, the arm 129 must provide attachment to the motor 123, that is offset from the cylinder and its pivot points, so that in the retraced position the motor can move past the cylinder. These clearances are accomplished while providing enough motion for the device to vibrate the boundary 17 and also clear the wall when retracted. If these dimensional constraints (of concrete placement device 3′) were not present, the double pipe design shown can be replaced with a simpler single pipe design. Alternatively, the flexible shaft can be replaced with a rigid, curved shaft to avoid any need for a curved pipe; though a goal of the present design to allow use of an off-the-shelf vibrator having a flexible shaft. The present design allows for both a curved path, to extend out from the side and curve downward, and then to extend in a straight path. This combination of paths provides a means to clear the reinforcing and extend downward. This combination can also be achieved by replacing the outer pipe with an attachment of the inner pipe to the motion of the arm 129, where hat motion can be stopped while the translational motion of the shaft can be allowed to continue. This is not a simpler design, but it does eliminate the need for any outer (second) pipe.

The flow control sponge 57′ in this case, which can be a high-density neoprene, is shown as a generalized lubrication pad, attached to the nozzle 106. It also can be supplied with a source of water to lubricate both the device 3′ travel and the beam 30 against the concrete. It also can be used to keep the top of the beam 30 clean.

12B shows a range finding system 235 that can be placed on the nozzle above the concrete placement opening for purposes of determining the distance to an excavated surface 11′. This is described in the disclosure at FIG. 25.

### FIGS. 13 and 14

This pair of images, 13A and 13B, shows side views of the low-profile nozzle 106, having a flow confinement system 138: A, in the retracted position; and B, in the extended position. FIG. 14 is the same thing, but showing top views. Relevant FIGS. 9 through 12 disclosure that applies to this system is generally not repeated here.

A flow confinement system 138 consists of a flow-directing lid 140 that is a plate formed in an arc, so that it can rotate about the center of that arc, as guided by a concentric guide 141 at each edge. The lid 140 rotates to an extended position where it confines flow of concrete after it leaves the nozzle 106, and is given an arc to clear the top of the nozzle, which is a surface that is clear of interference with the lid, and can be a concentric arc. The guides 141 are held by a fixed lid 142, which can be formed in a concentric arc, and two of a connecting plate 148, which affixes the guides 141 to the nozzle 106. The guides can simply utilize the nozzle top surface and fixed lid for guidance, what an end plate connecting those two. The center of the lid arc can be at or near to the pivot of the arm 129, so that the action of vibrator 123 and plunging of its head 72 can also engage rotation of the lid 140. The purpose of the lid rotation is to direct the motion of the vibrator flexible shaft 71 to be clear of the reinforcing 5, and to confine the flow of concrete by directing it downward. It also provides a means of retractable extension toward the reinforcing, so that engagement with reinforcing can be made for purposes of resisting form pressure. The retraction is provided to clear prepositioned elements in the wall plane; if these are not present, then the extension and retraction motions can be avoided.

The extension of flow confinement system 136 can be used to bring a magnetic tie system 144 close to reinforcing members 5, in order to engage them magnetically, in this case showing use of an array of a solenoidal electromagnet 145. Where reinforcing is tied back to the exterior of plane 11 with a series of the ties 25, which can be tied to the reinforcing wire of previously-installed stucco, or can be tied to the backing plane such as with a bearing washer 146 (of FIG. 14) where stucco can be placed after the concrete wall. This analysis of using stucco ties as form ties is presented more thoroughly under FIG. 4.

This embodiment of a magnetic tie system is suited to use of reinforcing mesh panels rather than individual rebars. For either of these embodiments, it is preferable that the vertical bars are closer to the magnetic engagement, so that a horizontally-oriented device can intersect the bars. In this case the required magnetic force can be determined with an assumption that at least several magnetic ties are engaged with a bar. If these take all of the fluid force from vibrating the concrete, previously calculated to be in the range of 45 pounds. A target magnetic design force can be approximately 100 pounds, which if divided among 4 bars (in contact with it), is 25 pounds per bar. Mesh panels provide a smoother surface and so jobsite conditions will have less variation on the effect of magnetic engagement.

FIGS. 13 and 14 with 20

FIG. 20 shows a section view of one of the solenoidal electromagnets 145, cut where it is pinned to each of a link plate 149 the bar 150, showing the “magnetic copper” wire winding in section, within the outer case. The electromagnetic problem to solve is to provide a stronger net magnetic attraction of the contact to the aggregate of bar 150 to the reinforcing 5 than the total of solenoidal electromagnets 145 have for their own armatures 152. This weakening of the solenoid pull force can be accomplished by making the bar 150 out of magnetized material or of material that accepts residual magnetism; and/or by providing a spring 153 with appropriate stiffness to offset the solenoidal force; and/or by making the armature either small enough in diameter or only partially of iron and including some less-magnetically permeable material. This allows a permeable flux path to extend attraction to the bar 150, while creating less solenoid retraction force. In all cases, the coil force can be relatively strong, with an armature that does not react as strongly. This way, the coil magnetic field can attract the bar and the reinforcing. Proximity of the solenoid coil to the bar 150 is key to the device, in allowing the coil magnetic field extending to the bar and the reinforcing bars. These solenoid modifications make it possible.

The solenoid would preferably have an environmental degree of protection of IP 68, where the solenoid has maximum protection from foreign bodies and water submersion. To provide a less sudden pull, which can upset rebars or break stucco-ties, the solenoid can be damped, by ohmic resistance, use of a varistor, by use of diodes, or by inclusion of a fluid (such as hydraulic fluid) within the unit. As this solenoid has significant side loading, it will wear relatively quickly, however the damping will help. To extend the life, a bearing can be provided at the seal 151.

The distance of projection of the magnetic flux from the solenoidal electromagnets 145 can be extended by use of the method disclosed in U.S. Pat. No. 5,929,732A, Apparatus and Method for Amplifying a Magnetic Beam, by Boyd B. Bushman, incorporated herein by reference, whereby an array of permanent magnets can be arranged with like poles directed toward and perpendicular to the electromagnet. This method can extend the flux field of the central magnet (or electromagnet) by several times.

A sequence for engaging steel reinforcement to resist concrete fluid pressure, and place concrete, can be as follows:
1. Extend the lid so that relevant elements of the magnetic tie system make contact with reinforcement elements.
2. Power the electromagnets to attach to rebar.
3. Retract cover at a controlled force (pneumatic cylinder pressure adjusted to tension the stucco ties but to not detach the magnetic tie).
4. Pump concrete.
5. Depower the electromagnetic tie.
6. Move to a new adjacent location to place concrete there.

This sequence applies to other embodiments using magnetic force to resist concrete form pressure. Corresponding terminology will vary. The lid 140 can also be utilized as a platform to attach tone or more of the rebar hooking device of FIG. 4A, which can be simplified in that the rotational action of the lid can substitute for the action provided by cylinder 93 (of FIG. 4A), and cylinder 94 can be rigidly attached to the lid.

### FIGS. 15A and 15B

These show a placement device 3′ having a modified flow confinement system 138′. Elements such as actuating cylinders or drive motors are removed for clarity. The system 138′ has a lid 140, a confining bottom plate 194, and two of a confining side plate 193. These plates can surround the nozzle 106, or the bottom plate 194 can be omitted—replaced with a flange element at each side for guidance. The side plate 193 is indicated at its outer edge, where it also can act as an extension of the flow confinement, and it is shown aligning with the nozzle edge in the retracted position (FIG. 15B); though it, and the bottom plate 194, can be set back from the nozzle edge so that they do not extend so far into the concrete placement (FIG. 15A). These surfaces act together as a nozzle extension to improve concrete placement, and can also retract to clear pre-situated elements, as described previously. This extension action can be rotational (as shown and as described previously), or it can be linear. These inner guiding surfaces can bear directly against the nozzle surfaces, or utilize reduced friction from a number of a linear seal 202, or the like, which can be a hard rubber gasket material. The flow control sponge 57′ can be modified and shaped for this purpose.

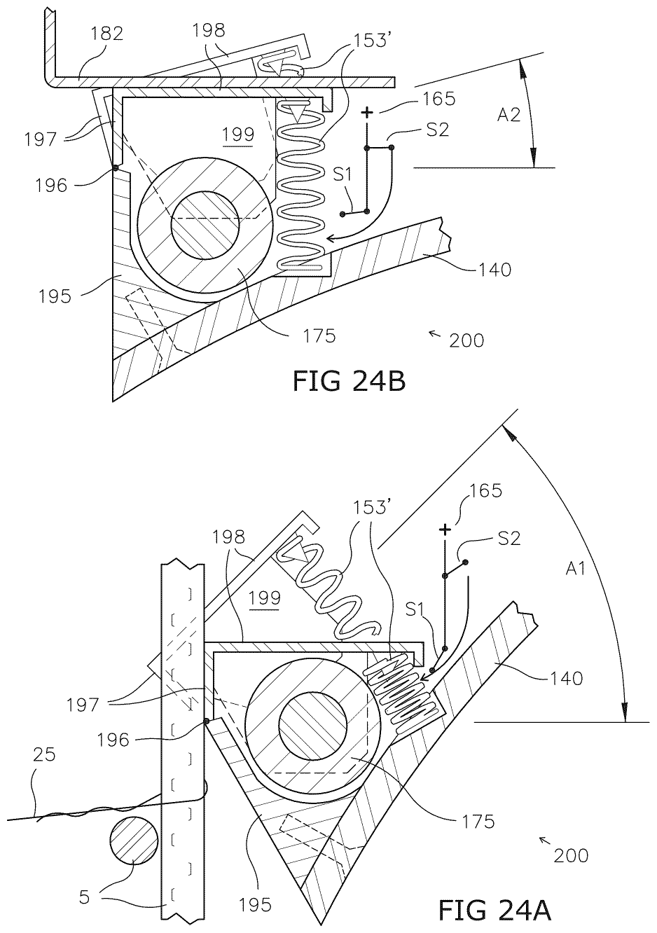

FIG. 15A shows system 138′ extended to where a contact-activated electromagnet device 200 is engaging a vertical rebar 5, to resist concrete fluid pressure as previously noted. This electromagnet is, or electromagnets are, energized by contact with one or more of a rebar engaging a spring-loaded switch, described at FIG. 24. Subsequent retraction of the vibrator, while the electromagnet is engaged, can occur providing the retraction force does not exceed the electromagnet pull. That force can be limited, as described per FIG. 21, so that the vibrator retraction can simultaneously serve as the tensioning action of the ties.

FIG. 15B shows a pre-situated ledger channel 182, of galvanized light-gage-steel track member, as light as 18 gage, or the like, which can stay in place or remove, to create a recess for a wood ledger, or a key for a concrete floor. The line 177 indicates the face of the subsequent concrete wall above. The channel 182 can itself act as a channel ledger, for support of a light-gage-steel floor or roof system. In this case, a stub joist 183, or a full-length joist—which either can be a typical galvanized light-gage-steel framing member, or a wood-material I-joist member—can also be pre-situated, and in combination with a brace 8′, or the like, as a means to pre-position the ledger, and so to define the location of the wall. An anchor strap 184 attaches to the top and/or the bottom flange of the ledger channel, in this case with both legs connecting at a plate washer 185, where a bolt 186 connects through the far side of the backing plane 11 (with a large bearing washer not shown). The bolt can preferably be synthetic non-thermally-conducting material, such as fiberglass threaded coil rod. The anchor strap 184 serves both purposes: It locates and positions the backing plane 11, while also providing permanent seismic anchorage of the wall to the floor diaphragm. It can be of 16 gage galvanized steel, or the like, and can have a tail (shown at the upper leg) with pre-punched fastener holes, to provide drag-attachment into the floor diaphragm by fastening onto a floor framing member. It can have a folded flange (not shown) to prevent buckling for resisting light compression force in locating the panel 11, or that compression force can be taken with a combination of the rebar chairs 147 and a block 188—where the block and a u-bolt 189 connected around a rebar, or similar connection, can be used to provide the temporary vertical support for the ledger. Alternatively, the strap 184 can tie to a horizontal rebar put in place for the purpose of supporting the ledger. So, in these embodiments, a combination of a rebar and a brace, locate the line of position for the ledger, and define the wall plane at that line. The presence of the stub joist (or a pre-situated floor skeleton) is required to allow the brace 8′ to be clear of the placement device 3′ while at the top of this wall section (or the brace can contact the wall backing plane at a higher point).

A guide track 178 can be located on the stub joist 183, at a determined location from the ledger 182, so that it can be utilized to guide each vertical beam 7. In combination with the tracks 190 (of FIG. 2) the guide track 178 can define the motion of the wall concrete placement system, so defining the plane of the wall.

To allow concrete to be placed to above the bottom of the ledger, and above the placement device, the placement device can be made to attach tightly to the ledger, so that concrete can be pumped with enough pressure to lift it to that level. The attachment of the placement device to the ledger can be made by one or more of the same contact-activated electromagnet 200, as described in FIG. 24B. The placement device is removed by depowering the electromagnet and lowering the beam 30. When concrete has sealed off the wall face up to the ledger, the concrete behind the ledger can be placed conventionally from above. After that concrete has set sufficiently, that floor can be entirely framed out and decked, so that the next story of wall concrete can be placed.

### FIG. 16

FIGS. 16, 17 and 18 show different views of the placement device 3″. It is helpful to have all 3 in view for the description of each. The similarities with previously disclosed embodiments are not repeated.

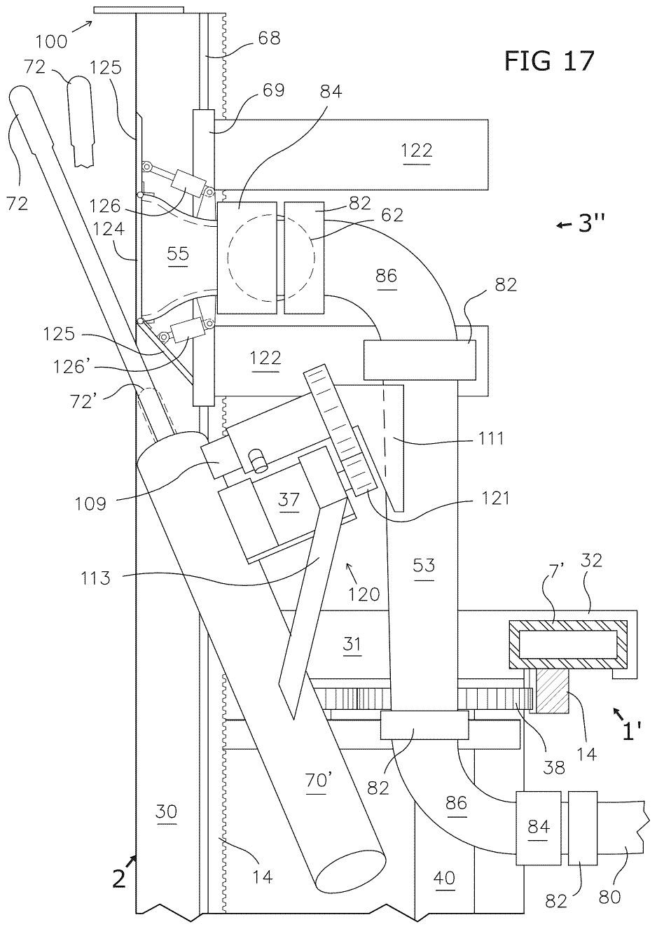

The placement device 3″ is in the vertical orientation shown from the side. Swivel/mixing pipe 53′ shown here, having a number of the mixing vanes 54, is otherwise the same as the swivel pipe 53 of FIGS. 17 and 18. It is connected to an elbow 86 at each end with a clamping couple connection 82. The lower elbow clamps to a swivel 84, and this is where the loads to clamp and swivel are the highest, due to the size and length of pipe 53, and the weight of concrete in the line, including that in the hose 80. Where the swivel pipe is also an inline mixer, then the upper elbow 86′ can serve as a point of admixture injection with a quill 91, fed by an admixture line 90. The upper swivel 84 should be largely parallel to the lower swivel to facilitate motions.

A nozzle 55 is attached with swivel 84 (the non-rotating portion), guide channel and motor 62, making up a carriage for the placement. This connection (not illustrated here) is highly loaded because of swivel pipe leverage, and must be designed accordingly. Nozzle 55 has a faceplate 124, and two of a wing plate 125 (more clear image following), each with action controlled by a wing plate actuator 126. These plates serve to aid consolidation by directing concrete away from the top of the beam 30.

The actuating vibrator 70′ can be just like vibrator 70, except that it does not project through the nozzle case. In this case it has a mount that rotates at pivot 109, where servo motor 37, with motor bracing 113, can rotate itself about a fixed ring gear 121. All of this is attached to the swivel pipe with a braced connection 111. When in the retracted position, vibrator 70′ and head 72′ are clear of the wall surface plane. If the lower swivel 84 is perpendicular to that plane, this will be true for all rotations of the swivel pipe. If the pivot 109 lines up closely with the bottom edge of the vibrator cylinder body, then this will also be true for all rotations of the vibrator. This type of fixed-ring gear pivot control can also be used for control of the swivel pipe rotation.

### FIG. 17

This shows the top of the beam 30, with the swivel pipe 53 rotated to a horizontal position, to show how it keeps hose 80 clear of vertical beam 32. Further rotation of pipe can be prevented by a pivot stop 122. The vibrator 70′ is adjustably sloped to allow the head 72 to reach placed concrete (not shown). As vibration can be applied while the placement device is moving (down the page in this illustration) the typical flexible shaft of the vibrator will cause the head to splay closer to the face of the beam 30 (the head 72 shown isolated). In the retracted position, head 72′ clears the plane of concrete placement.

The face plate 124, above the nozzle 55 opening, terminates at each edge at a hinge for each wing plate 125. Extended actuator 126 positions plate 125 at the face of concrete, to assist with consolidation of “downstream” concrete as it discharges from the nozzle. The retracted actuator 126′ rotates the corresponding wing plate away from concrete placement, so that it can clear previously-placed concrete from the top of the beam. The actuators can be solenoids, or pressure cylinders, or air bags. The control is preferably based on the direction of motion of the system, which is the control sent to the motor 62.

### FIGS. 18A and 18B

These face-views of the device 3″ show concrete placement where the device 3″, that started from the left end of beam 30 at control joint creator 100, is moving from viewer's left to right. The concrete being placed 15 is vibrationally consolidated and intermixed across the boundary of the previous placement 17.

FIG. 18A shows the swivel pipe 53 at a typical inclination for concrete placement, where that angle of slope (allowing the concrete hose beyond to clear the vertical beam 7′) can be determined by the hose support system (91′ of FIG. 3A), or by a ring gear system such as the vibrator 70′ has (FIGS. 15 and 16). The location of the pivot 109 defines the intersection of the vibrator with the swivel pipe, and the relative angle between the two can be set to idealize the position of head 72 for optimal vibrational consolidation.

FIG. 18B shows a difference when device 3″, because of successive lifts of beam 30, is getting near to the top of the wall (foreground). Clearance under strut 65 (or overhead beam 20) can become an issue, so swivel pipe 53 can then be rotated to the horizontal, and vibrator 70′ is set at a slope that provides consolidation, and also allows clearance under strut 65. For the last pass of concrete, where clearance may be minimal, the vibrator can also be rotated to horizontal (shown dashed); where with the head 72′ retracted, it can remain clear of the nearest wing plate 125. In this orientation it cannot vibrate concrete, so the face plate, in combination with the wing plates, can provide sufficient pressure to push concrete into place—such as underneath member 13 (of FIG. 9). The amount of swivel of pipe can be limited to an advantageous maximum by conventional means.

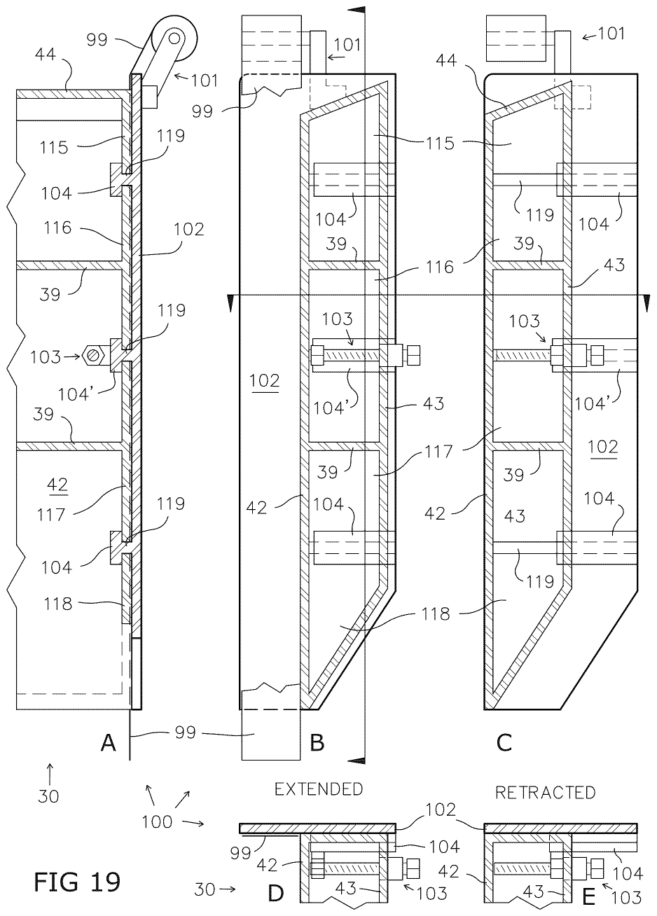

### FIG. 19

The control joint creator 100, located at the end of beam 30′, is shown in a few section views. A control joint plate 102 is shown in both extended and retracted positions. This motion is guided by a number of a tee slide 104 that slides into a slot 119, with a tee-shaped opening through plate 43 to allow motion thought that plate, at each slot. An upper end plate 115 creates a gap 119 with middle plate 116, and this with middle plate 117, creates another slot 119—which is not visible because of threaded adjuster 103; and plate 117 with lower plate 118 creates another gap 119. All tees are attached to plate 102, by fastener or weld. Tee 104′ supports a conventional threaded adjuster 103, which is a threaded rod spun within a cylinder, with keepers, so that it travels a threaded nut attached to tee slide 104′. Rotation of adjuster 103 can be accomplished by a rotational tool having a socket, or by a stepper/servo motor, not shown.

A strip dispenser 101 holds a roll of separation strip 99, in the manner that a packaging tape dispenser holds a roll of packing tape, allowing controlled-frictional unrolling. The strip material can be mylar, vinyl, etc in roll form, much like the heavy-duty tape for masking stucco, et cetera, but without adhesive on the face that runs down plate 102 as system 2 lifts. The strip is started at the floor/ground and may require some anchorage—such as a weight or fastening—to assure that as beam 30′ is lifted, the strip stays with the just-placed concrete (that is pressing against plate 102), and unrolls with each lift of the beam. When in the retracted position and not needed, dispenser can be removed if required, and can use a drop-slot attachment for that purpose. If a control joint is not wanted, the plate 102 can be used only to contain placed concrete as a starting edge for the next positioning of frame 1. If required, a bonding agent can be applied to that edge for improved bonding to the subsequently-placed concrete. In most cases, placement from control joint to control joint is preferred.

### FIGS. 21, 22A and 22B

The articulating magnetic tie system 154 is shown attached to the lid 140 of the flow confinement system 138 (of FIGS. 13, 14 and 15), where other elements of that system are shown for orientation. The rotation of the lid is utilized to bring the tie system into proximity with the reinforcing bars 5, then rotation of the lid is utilized to take up tension in the stucco ties 25, and then it is utilized to retract the tie system clear of the wall plane; so in this embodiment there is coordination between these two systems.

An array of an electromagnet engager 155 are attached to a connection bar 156, which is of a non-magnetic material such as aluminum. Centered in each engager is a coil 175, each positioned and secured by a hole in the bar 156. The coil axis is oriented vertically, so that when energized it will attract a lower plate 157 and an upper plate 158, effectively locking them to the coil ends. Attached to these plates, with a series of rings or a wire spiral to allow hinging action, are a lower link plate 159 and an upper link plate 161, these plates having a similar connection to a face plate 160. All of these plates can be of 1.5 mm thickness or the like, and the connection between can be spiral wire of 2 mm diameter or the like, having a 5 mm pitch or the like. These joints can also be that using a piano hinge, a double-nested hem, or similar. All of these elements should be of magnetically soft material, such as permalloy. When no outside forces act upon this system, a spring 153 pushes the face plate away from the coil, to the stop provided by the opposing lips on the lower and upper plates that engage the coil. The spring can be fixed to the face plate, or the face plate can slide vertically relative to the spring (shown here). To keep the top and bottom plates onto the coils, a horizontal keeper flange engages another keeper flange, which can be attached to the coil. These are shown as unlabeled dashed lines. This non-critical feature can vary.

The first purpose of this system is to engage reinforcing members that are not perfectly in position, and may be out of plane—within a range of roughly a half an inch relative to each other. The system is designed to engage vertical rebars. In one action, the system can make contact and engage two or more rebars that are misaligned with each other, within typical construction tolerances for wall reinforcing. The second purpose of this system is to provide a means for the upward-tangential direction of the lid to provide sufficient horizontal component for tensioning of the stucco ties while the rebars are engaged (avoiding relative sliding). A third purpose of the system is to recognize which engagers are making contact with rebars (randomly located relative to this device), and only energize those needed coils at contact point, without wasting power energizing the unneeded coils (which for typical rebar reinforcing, are typically the vast majority).

As the lid is swung down and toward rebars, only some of the engagers will make contact. This can be determined by providing low voltage 163 to any of the plates. If contact is made with a (grounded) rebar, the current generated activates a normally-open solenoid switch 164 (the switch is actually located away from the coil magnetic influence). This activates a power source 165 which energizes the coil, locking the lower and upper plates and providing enough of a magnetic field, combined with the permeability of the face plate providing a flux path, creating an electromagnet, to attract itself to that rebar. FIG. 21 shows two engagers 155 making contact, with the majority of engagers 155′ not making contact. The coils are shown as dashed circles here, but rectangular coils are also good to use for this. The face plate can also be more substantial, and also magnetized with opposing polarity—of a degree that helps attraction to rebars when the coil is energized, but no so much as to prevent the lid from retracting when the coil is off. Then, the lid is retracted, and the cylinders 135 (of FIGS. 2, 13, 14 and 15) are set to a controlled force, to tension the stucco ties 25. This force control can be attained by adjusting the operating air pressure of pneumatic cylinders, which can be field verified and readjusted anytime. To retract the system, the power source 163 is deenergized (a global switch not shown), and the lid will retract from the existing cylinder force. Normally the cylinder air pressure for pre-tensioning stucco ties is sufficient for lid retraction and extension.

These electro magnets can be electro permanent magnets, for the present devices or that of FIG. 20. These are semi-releasable, but can be switching or cancelling, by using parallel or opposing poles. Any residual magnetism helps make contact with rebar.

### FIG. 23

A permanent magnet engager 166 operates in the same principle are engager 155, where the electromagnet principle is replaced with a switchable or partially-switchable permanent magnet. The working geometry of, and materials for, the plates 157, 158, 159, 160 and 161 is the same or similar. In this example, a rotary solenoid, or similar rotation control device, is torsionally-affixed to a series of a permanent magnet 167 that rotates with a non-magnetic core 168. This can be continuous along the near-edge of the lid 140, where only one or two of the rotational solenoid 169 are present. The face plate adjacent to the solenoid, or on both sides of it, can cantilever to cover it—and provide a location of attraction of a rebar that may be located there.

This example is based upon the principle of the patented device: Semi-Releasable Magnetic Tool, U.S. Pat. No. 7,009,480B2, by Gary Tsui, and Daqing Zhu, incorporated herein by reference, where permanent magnets are rotatable by 90 degrees, to engage or disengage a magnetically-permeable material covering, known as a semi-releasable magnet. When the magnet poles are adjacent to the magnetically-permeable covering, it provides a flux path and attracts ferrous objects to the covering. FIG. 23 is shown in this engaged position. A 90-degree rotation will direct the magnet poles to the spring—which can be non-magnetic austenitic stainless steel, and the bar 156′ with is non-magnetic. If an iron strip is provided along the magnet poles, its permeability will tighten the flux field in the off position, so that stronger magnets can be used. This will allow magnets of over 100-pound-force to be effectively disengaged. This system can also use the more powerful magnetic switching, where the rotation of aligned magnet sets can cancel or double magnetic forces, depending on like-pole or opposite-pole alignments. This method usually requires a 180-degree rotation, which then requires the rotational solenoid 168 to be replaced with a servo motor or the like.

### FIGS. 24A and 24B

The contact-activated electromagnet 200 has dual modes of activation, and preferably each can have a different level of power delivered. These magnets are provided at or near the end of the lid 140, contiguously in a row, such as the electromagnet engagers 155 as shown in FIG. 21, with a difference being that the connection bar 156 is replaced with a face bar 195—of non-magnetic material such as fiberglass or aluminum. In the “form tie” mode of FIG. 24A, it is possible that only one electromagnet engages one rebar, and so the single attractive force must be sufficient to resolve the tributary concrete fluid pressure attributed. When the devices are in the “ledger seal” mode, all of them can be engaged to the ledger 182, so less power is required for each.

FIG. 24A shows the pivot action of a connected face contact plate 197 and top contact plate 198 about a hinge point 196; these are normally kept at an angle where face 197 projects away from face bar 195 with an attached spring 153′. In this case, face 197 is shown as a 15-degree turn from a face 195 that is 30-degrees from vertical. These angles can be seen at the device beyond the rebar. Both of these angles are arbitrary. As the lid 140 is extended toward the vertical rebar 5 (connected with a number of the stucco tie 25 in this case), the contact of the rebar with face 197 rotates it back to something approximately vertical—in this example an approximately 45-degree rotation shown as A1. This action closes a switch S1, so power supply 165 is delivered to the coil 175, with poles roughly perpendicular to the rebar. The magnetic flux permeates though the side plates 199 and returns though the other contact plates, attracting the rebar. The thickness of side plates can be greater than the others, if necessary to confines the flux within, so that it does not affect the adjacent unit side plate 199. For a given electromagnet, the magnetic permeability of the lid 140 material is a consideration; and so for this electromagnetic device, is preferably of aluminum or composite rather that steel. When it is time to disengage the rebar, the power supply 165 is shut off with another switch.

FIG. 24B shows the pivot action of the face and top plates when the electromagnet makes contact with a horizontal surface such as that provided by the bottom flange of the channel ledger 182. The lid 140 is in retracted position so that face 195 is vertical, and in this case the face plate 197 is angled 15-degrees to it (shown on the angles of device plates that are positioned as before contact). The motion making this contact is that of the vertical travel system 34 (of FIG. 1, etc), where the placement system is run up to the top of the wall being placed. So, when the top contact plate 198 is rotated to approximately level, 15-degrees or angle A2 in this example, switch S2 is closed, powering the electromagnet 175. As this attraction does not need to be as strong, the rotation A2 activating switch S2 can correspond to a different lower voltage power source, or an override to all S1 switches can be engaged by another system, automated or manual, to electrify the electromagnets to an appropriate amount of power. Alternatively, switch S2 corresponding to rotation A2, can close at A2, and if rotation continues, switch S2 can remain closed, until nearing rotation A1, where switch A1 can also close (while the power from switch S2 is on), creating the additional power from an additional source.

If any of the electromagnets are attracted to the ledger channel flange before (the top) rotating to horizontal, some indentation can occur at the top of the concrete wall. Alternatively, if any grab the ledger too soon, it may force the device 3′ slightly toward the wall. Any resulting low minor spots in the wall surface are preferable to high spots, as they do not interfere with any subsequent plaster finishes that may be desired, etc.

The gaps between the devices (between the side plates 199) will receive some cement intrusion from the concrete fluid pressure. If preferred, a rubber gasket can be placed in the space between adjacent units, attached to face bar 195 and lid 140, and a space created by such a gasket can be preferred to increase flux though the side plate of the device in contact with the rebar. The hinge 193 can be a piano hinge or the like, in that face 197 can effectively be one leaf of it, and the other leaf can recess into the face bar 195. The use of switchable permanent magnets, such as disclosed per FIG. 23, can also be employed for these contact devices, wherein the rotations described, enable the magnetic attraction. The greater rotation having a greater magnetic affect; rotating back to release. The magnetism does not need to be completely eliminated—just enough to allow the device to disengage with retraction of the lid.

### FIG. 25A

Even without linking placement rate to concrete pumping rate, these slip-forming placement methods can allow manual control, or even some automation or semi-automation, because successful concrete placement with these methods is less critical and more forgiving than is 3D-printing. However, synchronizing placement and pumping is clearly beneficial for automation and productivity of the placement system. Here are a few embodiments enabling the concrete placement system to synchronize with the concrete flow volume 236 provided by the concrete pump 220, as depicted on FIG. 3, which can be any type of concrete pump. In one embodiment shown in FIG. 25A, a CPU 221 can respond to a digital model of the concrete wall to be placed, where the model is converted into tool paths using G-code, or similar additive manufacturing slicing software, for concrete placement. This model can provide information on wall plane location, height, length, thickness, window locations, etc. For total hands-off digital control, the CPU would also provide at least some control to the concrete pumping action, though a device controller (represented here as a signal 203), so that the volume of pumped concrete can be controlled to proportionally match a predetermined placement travel rate, and to shut off the concrete pump when placement needs to stop, etc.

For an engine-powered concrete pump running at a given setting of the engine throttle, the rate of concrete flow volume can vary due to motor/engine load/performance, changes in concrete viscosity/friction, and other variables, so it does not pump concrete at a precise volume at a given setting or set amount of power consumption. The placement device travel rate is then ideally linked to the not-entirely-controllable analog concrete pumping rate, so it advances proportionally to the concrete volume flow provided by the concrete pump, and it can adjust to changes in the concrete pump's rate of volume flow.

Alternatively, the placement device rate of advancement can be linked to other means of measuring concrete volume flow, such as pressure sensors in the beam 30 (of FIG. 1)—the pressure readings determining consolidation of placement, per previous disclosures by this same inventor. Or, video can be monitored by AI in order to constantly evaluate and determine the volume of material placed, for device motion advancement, or for adjustments to device motion management.

Concrete flow rate can be determined indirectly by pump mechanical motion or hydraulic fluid motion, which are proportional to concrete flow volume, or by direct measurement of concrete flow. The latter can be simplified by physically smoothing the concrete flow variations, or by electronically smoothing measurements in order to provide an average flow rate. These types of systems were disclosed previously by the present inventor, in the referenced files above. The automated placement system controls the amount of concrete placed by controlling the advancement the placement device appropriately relative to the concrete flow rate.

Alternatively, the motion of the placement device can be to pause while placement is made and vibrationally consolidated, then advance to the next placement location, and it is possible that these steps can be made to simply coincide with, or significantly coincide with, the pumping and pausing sequence, or periodic fluctuations, of a cylinder switching type of concrete pump, particularly in that the electronic control for these pump actions can also be utilized to control the placement device. The primary issue with this placement system control embodiment is that the swing-tube (cylinder switch) crossover pause is very short compared to the discharge from each piston. The amount of volume in a large concrete pump cylinder can be up to 85 liters, which could fill up a 150 mm by 150 mm concrete placement to a length of over 3 meters. There is no practical or safe way to relocate a placement device over that distance within about a second. However, for a small piston pump, having a cylinder volume of around 5 liters, the same section of concrete placement would correspondingly be about 22 cm. It is feasible to complete most if this distance in about a second. The next consideration is whether the concrete will be consolidated sufficiently if the placement device moves immediately after placement without further vibration.

Here are parameters for the simple case of using what is determined to be a steady uninterrupted averaged flow of concrete (Q) in order to determine a continuous steady rate of motion for the placement device, where the flow rate Q fills a volume V, per unit of time. The ideal height of each lift (h) is chosen. The wall thickness (w) is determined. These values are part of the digital model that defines tool path and the volume of concrete associated with it. Any variation in either of these values can be known, or as part of an onsite-revised modified digital model, such as that based upon lidar measurements, which would use them to determine a tool path rate-of-travel (R) that is proportional to a given rate of flow of concrete; that rate-of-travel being inversely proportional to the wall thickness and lift height, and modified proportionally during placement according to any change in volume of concrete flow:
V=(R*t)*w*h, where (R*t) is the distance the placement travels per unit time, t. And, Q*t=V, so, Q*t=(R*t)*(w*h). Therefore, Q=R*w*h, and R=Q/(w*h) With correction modifiers applied, R=C_{U}*C₁*(C₂*Q*C₃/(w*h))

Modifier C₃ is simply a geometry/unit conversion that may or may not be necessary. C₂ is a proportion modifier based on what specific type of rate is actually measured to determine Q. It can be the measured rate of concrete linear movement multiplied by the hose cross-section area, or the volume of hydraulic oil flow extrapolated to represent concrete volume flow, etc. Modifier C₁ can be used as a correction factor that can be adjusted to provide optimal placement, such as the proportion between projected and actual concrete flow rate. This value may change over different ranges of pumping rates that are measured indirectly, such as where the control signal to the concrete pump is hacked to also control placement rate. This value can be assigned to any given concrete pump and method of measurement of that pumping action, and then stored to be retrievable for that specific use. C_{U} is a user correction modifier that defaults to 1, and can be assigned a different value at any time, based on how a specific job is going.

For the case of the placement device making repeated stops at each location of concrete placement, then moving to a new adjacent location for a subsequent placement, the volume, V_{M} of each such placement is w*h*d_{M}, where d_{M} is the distance traveled to the next placement. If R_{M} is the rate of travel between placements, and t_{M} is the time between placements (time moving), then d_{M}=R_{M}*t_{M}. If pumping stops at between each placement, the time of placement t_{P} is the placement volume V_{M} divided by the flow volume rate Q.

$${V}_{M} = w ⋆ h ⋆ {R}_{M} ⋆ {t}_{M} , so {R}_{M} = {V}_{M} / ( w ⋆ h ⋆ {t}_{M} ) ( without correction modifiers in place )$$

If the pumping continues during pause time t_{P} and during travel time t_{M}, then the volume of the void V is still w*h*(R_{M}*t_{M}), but the volume of concrete pumped V_{P} is Q*(t_{M}+t_{P}). If t_{M} is assigned as a maximum (beneficial) rate of travel, then the time paused for placement, t_{P} is:

$${t}_{p} = {t}_{M}^{⋆} ( {R}_{M} ⋆ w ⋆ h / Q ) - 1 ) ( without correction modifiers in place )$$

If this equation results in a negative value that means that the rate R_{M} is too slow even without pauses. If R_{M} cannot be increased, and the lift height cannot increase, then it is most likely that the concrete pump needs to be slowed down. Also, for concrete vibrational consolidation purposes, particularly where internal vibrating can only be applied while placement is paused, t_{P} may need to increase purely for consolidation purposes.

Where a wall thickness w is not known, such as when of placing concrete against an irregular excavation surface or the like, use of this type of automated placement rate, controlled by the volume to be placed, would require measurement of the excavated surface with lidar or the like, for input into the digital model, so that the material volume can be determined for all locations, and the tool path/rate adjusted accordingly. Alternatively, this measurement can be done real time while placing concrete, with an array of an attached range finder, such as 238 of FIG. 12. This device can also be lidar, or other proximity sensor, or any electronic time-of-flight distance sensor, where that distance is acquired during placement, and used to correct the volume of concrete needed, in real time, most often by changing the rate of travel or the time of pause. As any range finder will also find obstructions such as rebar or window bucks, giving false readings, so an array can be used with value filters to determine what really is the backing surface. This method can also be used to determine where the window bucks and other terminal edges of concrete placement are, for control purposes or control override purposes. This method can be used in lieu of a digital model, that is, the real time scanning determines the telemetry and making corrections. This can build or update a digital model as it places concrete.

During the concrete placement process, a digitally-defined tool path, rate of motion, and/or duration of stationary placements and distance moved between them, can be modified by user input 207 via the CPU, or by signal 206 from the concrete placement device, to a data acquisition unit DAU 225. In the case where there is not a predetermined digital model, placement device signal 208 can be one recognizable to, and be sent directly to, the servo controller 227, where it is of a design meant for such external signal input. Also, the RFID reader (87 of FIG. 3) or the like can provide path limit information, in locating any wall edges, and then would be information included in this signal. The CPU software can make decisions about closing a series of stationary placements, in optimizing the sequential placement distance (amount of travel between stationary placements) to terminate placement at a wall edge, or control where the control joints c should be, while keeping the rate of concrete flow approximately constant.

An external signal 204 or 205 can be information from a concrete pump control system, such as that of a given onsite concrete pumping service. These signals can be delivered to the placement system by wire, or by wireless transmission with a transmitter attached to the concrete pump. This can be signal information from the pumping rate control, in that it can be the same signal that controls the hydraulic pump powering the concrete pumping cylinders, so that the advancement rate of the placement device can be proportional to, or related to, the concrete pumping rate. User adjustment and correction can always be made in determining the correspondence between the placement system and a given concrete pump.

The motion control of the placement device is now linked to the concrete pump control, and so can proportionally match the flow rate of concrete pumping, including any rate change or interruption, even precisely enough for 3DCP operations or other types of digitally-controlled additive manufacturing means. Control of slip-formed placement is not as critical as for 3DCP, because either a surplus or a shortage of concrete volume can be compensated for at the subsequent lift, and either way the slip form will maintain the proper wall surface plane. If the proportional valve is out of adjustment for multiple passes, cumulative uncorrected volume mismatch can become a problem. So, these methods of automation can require some monitoring, or feedback correction, which is common with all cementitious 3D-printing methods, such as making sure the pump does not run dry of concrete. Video cameras mounted on the placement device can be very helpful for these purposes.

It can be the case that the user will choose an appropriate placement travel rate, or override to adjust the travel rate, as the concrete pump is running, and then allow the signal from the pump to correct that rate as the pumping rate changes. This is a linear function, where both the concrete pump and the placement system intersect zero (units per unit time). As the concrete pump actual output may have some variation from a linear function, then more data points at different pumping rates can be added by the user during monitoring. If the signal from the concrete pump is measurement of concrete volume flow, a single data point should be sufficient, as concrete flow volume is what the placement system rate is always proportional to.

More specifically, for cylinder-switching concrete pumps (such as swing-tube pumps), which generally have electronic control of a hydraulic pumping system, this rate signal can be the same that also controls the abrupt pause in concrete pumping during the cylinder switching action. Therefore, the concrete placement device can be made to pause advancement (if it is of the type that moves while placing concrete), so that the pause in pumping action does not cause a gap in concrete placement. In the case where the placement device is stationary while placing concrete, the missing volume of concrete due to the pumping pause can be compensated by simply holding that position for the additional time of the pause in pumping. In either case, the motion of the placement system can be determined by signals from the concrete pump control system, so that a variable flow of concrete can have a consistent volume of placement.

A simple example for this means, is to utilize the signal sent by a sensor on each hydraulic pump cylinder that initiates the switching action. This can be a proximity sensor that determines that the piston head has reached the end of its stroke (in the hydraulic cylinder). This signal, 204 or 205, can be that sent to the servo control 227, then pausing the advancement motor for a determined time period, or a restoring signal can be sent from the pump control to restart the placement advancement. There are many other places in the pump controlling system where the appropriate signal information is available to control the placement device.

If a pause signal 204 is sent from the pump to the DAU, then the corresponding signal from the DAU to the CPU can be processed to create a more sophisticated compensation response. The CPU can develop a timed ramp-down then ramp-up of the concrete placement device, so that hard stops can be avoided. The profile of the pause in motion can be adjusted to match the specific concrete pump in use. This is continuous real-time modification to the tool path, rate, and/or timing, based upon what the concrete pump is doing at that moment, and for stationary placements, it can be to simply hold position of placement for a slightly longer duration when switchover occurs. The servo motor encoding feedback information can serve to continuously monitor placement travel and position. The placement device can also be signaled to automatically stop all progress whenever the concrete pump is stopped, and this can be manually controlled.

The concrete placement systems disclosed can have reasons to need to stop concrete placement at any moment. Whenever the placement system needs to stop placement as part of the planned tool path process, the CPU can send signal 203 to stop the concrete pump. This stop can be routine, such as where the concrete placement device reaches the end of controlled travel, and slip form beam 30 (of many previous drawing figures) is lifted to the next height, so that placement can resume at the next-higher lift, where signal 203 is sent to resume pumping. This process can also ramp down and up to avoid hard stops, or the beam can lift at a rate that synchronizes with the concrete placement rate, so that no stoppage or slowdown is needed at lifts. Where the placement is needing to always start at the same end of the travel, like an analog typewriter carriage returns for continued typing, for conditions when the concrete is not holding vertical form quickly enough to go straight up, a pause or slowdown in pumping would be required for the carriage to return.

### FIG. 25B

A variable frequency device VFD 231 can control a 3-phase motor. This can be a good option where the placement device is manually operated, or partially manually operated, with onsite determination of the appropriate rate of placement, or duration of time for sequential stationary placements. Any of this can be automated. VFDs can also respond to digital input, such as when connected to a transmitter providing 4-20 mA reading for control purposes, or via a programmable logic controller, so the benefit of a digital model is not excluded with this type of control system, but it is not necessary. The user control 209 can set a rate of placement travel for continuous-motion placement. For sequential stationary placements, an adjustable timer relay can be implemented, if not present with the VFD. This allows the user to create time durations for travel and for remaining stationary, on the timer delay device, creating a signal sequence 210. These variables and the pause timing can be adjusted to match a given concrete pump. The signal terminals of the VFD can also receive a stop/reverse signal 212 from the placement device. This signal can also be utilized to initiate a lift of the slipform beam 30, and a concrete placement above the previous, before moving the placement device in the opposite direction for a subsequent placement. In this case with a VFD driving a 3-phase motor, there is normally a ramp-down/ramp-up with most speed control actions, so that hard stops and starts are avoided.

An external signal 211 can be that from the concrete pump, where the concrete pumping rate is used to control the concrete placement rate, as described for FIG. 25A. These systems can be duplicated for dosing a modifying admixture that is intermixed proportionally in the pump line. For example, another system of FIG. 25B can function in parallel for the admixture, using the same input signals, to provide a dose rate proportional to the concrete pumping rate.

### FIG. 25C

This schematic shows a means to utilize the concrete pump hydraulic power system directly to drive the concrete placement system proportional to the rate of concrete flow, at a point in the hydraulic lines where the hydraulic oil flow rate is proportional to the concrete flow rate. As the power demand of the placement device is only a small fraction of most concrete pumping system, there is sufficient power available for this purpose, even using the hydraulic lines that are discharging from having pumped the cylinders.

For a placement mode that directly corresponds to the concrete flow and pause of the swing-tube type of concrete pumping system, the rate of travel is then proportional to the concrete pumping rate, and the pause in concrete pumping during cylinder switchover will also automatically and correspondingly pause the placement motion. A concrete pump 220, has a pump control system that includes a hydraulic circuit for both the right and the left cylinders. The source to power these circuits is not shown. Each circuit, represented by line 216 (R), and line 218 (L), alternate between a high-pressure mode, and a lower-pressure mode; the low-pressure mode being the return flow. A return line control valve 213 is driven by pilot controls, so that it releases the lower-pressure line, to create a single return line 217, which typically connects directly to a pressure reduction valve 219, but is not shown that way here. In this diagram, the left cylinder side is at high pressure, so the left pilot is controlling the valve, to let the right side (lower pressure) flow through. Line 217 has a flow rate that is directly proportional to the concrete pumping rate, and is still of a high enough pressure to drive the placement device, which can operate with hydraulic pressures in ranges of hundreds of psi. When the concrete pump switches cylinders, line 217 pauses just as the concrete pumping pauses.

A tie-in valve 222 is installed on, or outside of, the concrete pump, which offers a normal position of feeding to return line 218. The tie-in valve 222 is shown in the open position, where it feeds the placement device 3. A pressure-compensated flow-control valve 226 can proportion an amount of total flow to the hydraulic motor; a bypass line returns the additional flow back to line 218, per usual practice. A check valve prevents reverse flow if pressure should be higher in the bypass line. The valve 226 is the speed control for a hydraulic motor 233, and it can be operated manually or by a more-sophisticated or automated means, via adjustment signal 229. There can be any other beneficial gear reduction from the motor to the placement system mechanisms, or this can all by hydraulically controlled. The motor 233 rotation direction, and stoppage, is controlled by valve 228, which can be controlled by the stop/reverse signal 212 (of FIG. 25B). Note that the middle envelope of valve 228 returns all of the flow back to the concrete pump, line 218, the same as does valve 222. Restricting this flow will affect the concrete pumping, so it should never be blocked by the placement device hydraulic system. The hydraulic load required for simple horizontal movement of the placement device is very minimal, so it has very minimal effect on concrete pumping action.

The pressure reduction valve 219 protects an oil drain system fed with line 223. It maintains the pressure level of the low-pressure mode. It should be verified that this low pressure is low enough for the return line of the placement device system to allow operation of the proportional controlled-motion system described here. If this is a problem, a synchronized hydraulic pump system could be required in the return line 218 beyond valve 228 (not shown), or an alternate return line 234 that runs directly to the oil drain system via line 223. Line 234 would in most cases need another pressure reduction valve like 219 (not shown), but set at a lower inlet pressure.

Adjustment signal 229 can be from a CPU though a device controller, in order to make necessary adjustments independently of the concrete pump rate. The CPU can also send a similar signal to the concrete pump for system corrections, stoppages, and to coordinate concrete pump stops with necessary carriage stops, etc.

Component varied embodiments of the present invention are generally interchangeable. For example, any of the concrete delivery devices or nozzle types disclosed can be used with any of the guidance frame designs, which can use any of the position-controlling means. For another example, the mobile platform 49 of FIG. 3 can be combined with the concrete placement device 3 of FIG. 1, or 3′ of FIG. 2, etc.

Lightweight and easily-relocatable systems are developed for very-rapid vertical slip-forming of concrete walls. Automatic placement and consolidation of rheology-modified pumped concrete, is performed for lengths of a wall between control joints. Effective vibrational consolidation about in-place reinforcing is accomplished, but with minimal overall form pressure, lowering system loading, lifting vertical slip forming out of the realm of heavy industry. Placement systems can synchronize to move proportionally with pumped concrete flow rates, allowing automated placement while utilizing conventional engine-driven piston concrete pumps, such as those already in service. RFID tags indicate boundaries of automated concrete placement. Highly-insulated walls, multi-story building geometry definition, and replacement of inefficient shotcrete operations are facilitated. Optional cladding ties, partially cast into the concrete wall, can also serve to momentarily accept form pressure by use of temporary magnetic connections by the slip form.

In the foregoing specification, the invention has been described with reference to specific embodiments; however, one of ordinary skill in the art appreciates that various modifications and changes can be made without departing from the scope of the present invention as set forth in the claims below. Accordingly, the specification is to be regarded in an illustrative, rather than a restrictive sense, and all such modifications are intended to be included within the scope of the present invention.

Benefits, other advantages, and solutions to problems have been described above with regard to specific embodiments; however, the benefits, advantages, solutions to problems, and any element(s) that may cause any benefit, advantage, or solution to occur or become more pronounced are not to be construed as a critical, required, or essential feature or element of any or all of the claims.

As used herein, the terms “comprises,” “comprising,” “includes,” “including,” “has,” “having,” “at least one of,” or any other variation thereof, are intended to cover a non-exclusive inclusion. For example, a process, method, article, or apparatus that comprises a list of elements is not necessarily limited only to those elements, but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

What is claimed is:

1. A system for casting a concrete wall, the system comprising:
a frame;
a slip form;
a placement carriage;
the frame being connected with the slip form so as to accomplish vertical movement of the slip form;
the slip form being connected with the placement carriage so as to accomplish horizontal movement of the placement carriage;
the placement carriage having a nozzle for attachment to a source of a fluid concrete;
wherein the casting the concrete wall is accomplished by the placement carriagemaking successive horizonal passes with vertical movements placing layers of the fluid concrete with the nozzle from a side of the wall, the layers of the fluid concrete being placed adjacent a backing plane; the fluid concrete having a composition allowing the fluid concrete to form a vertical surface after placement.

2. The system of claim 1, further comprising a vibrator connected with the placement carriage to provide vibrational consolidation of the fluid concrete.

3. The system of claim 1, further comprising an internal vibrator connected with the placement carriage and disposed so as to plunge into and retract from the fluid concrete for vibrational consolidation.

4. The system of claim 1, further comprising a flow meter to measure fluid concrete volume flow rate, the flow meter is connected with the placement carriage so that the placement carriage has a motion control rate responsive to the fluid concrete volume flow rate.

5. The system of claim 1, wherein the backing plane comprises a rigid material.

6. The system of claim 1, wherein the backing plane comprises a rigid insulating foam.

7. The system of claim 1, wherein the backing plane comprises an excavated surface.

8. The system of claim 1, wherein the backing plane comprises a slip form.

9. The system of claim 1, wherein the backing plane comprises an automated device.

10. The system of claim 1, wherein the concrete wall includes reinforcing elements.

11. The system of claim 1, wherein the frame positions itself using tracks.

12. The system of claim 1, further comprising a laser based guidance system or a GPS guidance system to define a wall plane for the concrete wall.

13. The system of claim 1, further comprising a digital model to define a wall plane for the concrete wall.

14. The system of claim 1, wherein the frame also supports the backing plane.

15. The system of claim 1, further comprising using ties for cladding to resist concrete forming pressure.

16. The system of claim 1, further comprising using attachment to rebar to resist concrete forming pressure.

17. The system of claim 1, further comprising using controlled magnetic force to resist concrete forming pressure.

18. The system of claim 1, further comprising using one of more of a pre-situated floor framing members with anchors attached, before the fluid concrete placement.

19. The system of claim 1, further comprising using a pre-situated floor framing member to define the concrete wall plane.

20. The system of claim 1, further comprising a device that collocates the relative positions of a pre-situated framing member relative to the backing plane also provides permanent anchorage of the concrete wall to a diaphragm.

21. The system of claim 1, further comprising using rebar to support a pre-situated floor member.

22. The system of claim 1, further comprising ties for cladding cast into the concrete wall.

23. The system of claim 1, further comprising ties for cladding utilized as form ties.

24. The system of claim 1, further comprising a device for range finding to determine the concrete wall thickness.

25. The system of claim 1, further comprising a device for range finding to determine locations of concrete wall boundaries.

26. The system of claim 1, further comprising a device for range finding to determine locations of concrete wall openings.

27. The system of claim 1, that defines a concrete wall edge.

28. The system of claim 1, that defines a concrete wall control joint.

29. The system of claim 1, further comprising a device to provide a bond breaker material for a control joint.

30. The system of claim 1, wherein the full thickness of the concrete wall to a finished surface is achieved in a single pass of the placement carriage.

31. The system of claim 1, further comprising a concrete pump, the control of the placement carriage system is responsive to the control system of the concrete pump.

32. The system of claim 1, further comprising a cylinder-switching type of concrete pump, having abrupt fluctuations in flow rate, utilized for automated concrete placement.

33. The system of claim 1, wherein the placement carriage is connected to the source of fluid concrete with one or more swivel connections.

34. The system of claim 1, wherein the system supports a length of concrete hose so that it can follow the concrete placement motions.

35. The system of claim 1, further comprising an RFID reader, RFID tags are placed onto locations defining boundaries of the concrete placement, to allow determination of boundary locations by the system electronically.

36. The system of claim 1, further comprising an RFID reader, and RFID tags are placed onto locations defining an element that is cast into concrete, for subsequent location of the element.

37. The system of claim 1, further comprising an RFID reader, RFID tags are placed onto locations of obstructions to allow electronic determination of a tool path that avoids the obstruction.

38. The system of claim 1, further comprising a controller for automated operation.

39. A concrete placement system comprising:
an analog concrete pump to pump a fluid concrete;
a motion control system for controlling the motion for placement of the fluid concrete, the motions for placement of the fluid concrete being controlled at a concrete placement rate of travel by the motion control system, the motion control system being connected with the concrete pump to receive from the concrete pump a concrete volume flow rate to a point of concrete placement, the motion control system having a system to advance the concrete placement rate of travel proportionally to the concrete volume flow rate, so that the concrete pump can synchronize with the motion control system.

40. The concrete placement system of claim 39, wherein the motion control system uses a control signal linked to the concrete pump and the concrete flow rate.

41. The concrete placement system of claim 39, wherein the concrete pump is powered by a hydraulic system, having a hydraulic oil flow rate that is proportional to the concrete volume flow rate, and the control of the rate of travel uses a hydraulic oil flow rate proportionally.

42. The concrete placement system of claim 39, wherein the concrete volume flow rate is measured directly.

43. The concrete placement system of claim 39, wherein the concrete placement rate of travel corresponds to periodic fluctuations of the concrete volume flow rate.

44. The concrete placement system of claim 39, wherein the concrete placement rate of travel is smoothed to an average of the concrete volume flow rate.

45. The concrete placement system of claim 39, wherein the concrete placement system compensates for momentary pauses in concrete flow.

46. The concrete placement system of claim 39, wherein the concrete placement system having at least one vibrator, and the rate of travel is periodically paused for the concrete placement that is consolidated by action from the vibrator.

47. The concrete placement system of claim 39, wherein the concrete placement system is automated.

48. A method of fluid concrete placement for casting a concrete wall, the method comprising:
pumping the fluid concrete having a volume flow rate into place from a side of the concrete wall and against a backing plane at another side of the wall;
performing the fluid concrete placement in sequential horizontal layers, starting at the bottom of the concrete wall and building vertically to the top of the concrete wall;
using a carriage to direct the fluid concrete placement along a horizontal path, the carriage being guided by a horizontal slip form member, the horizontal slip form member combined with the backing surface, providing temporary confinement of the concrete fluid pressure;
guiding the horizontal slip form member vertically using a frame support, where the positioning of the frame support defines the vertical surface of the concrete wall;
repositioning the frame to an adjacent position to define a continuation of a vertical surface of the concrete wall; and
raising the horizonal slip form member vertically at a rate of at least 5 cm per minute, defining a surface of the wall at a vertical rate of at least 5 cm per minute.

49. The method of claim 48, wherein the method uses a motion control system for the carriage having a rate of advancement that is linked to the flow volume rate of the pumped concrete.

50. The method of claim 48, comprises providing vibrational consolidation.

51. The method of claim 48, wherein the backing surface is a rigid material.

52. The method of claim 48, wherein the backing surface is of rigid insulating foam.

53. The method of claim 48, wherein the backing surface is an excavation.

54. The method of claim 48, wherein the backing surface is a slip form.

55. The method of claim 48, wherein the backing surface is an automated device.

56. The method of claim 48, wherein the concrete wall includes preplaced reinforcing elements.

57. The method of claim 48, wherein the carriage having a rate of travel that corresponds to periodic fluctuations of the pumped concrete volume flow rate.

58. The method of claim 48, wherein the carriage having a rate of travel is smoothed to an average of the pumped concrete volume flow rate.

59. The method of claim 48, wherein the carriage having a rate of travel that compensates for momentary pauses in the pumped concrete volume flow rate.

60. The method of claim 48, comprising use of least one a vibrator, and a carriage rate of travel that is periodically paused for the concrete placement while the fluid concrete is consolidated by action from the vibrator.

61. The method of claim 48, comprising using range finding to determine the concrete wall thickness.

62. The method of claim 48, comprising using range finding to determine locations of concrete wall boundaries.

63. The method of claim 48, comprising using range finding to determine locations of concrete wall openings.

64. The method of claim 48, comprising defining a concrete wall edge.

65. The method of claim 48, comprising defining a concrete wall control joint.

66. The method of claim 48, comprising using ties for cladding to resist concrete forming pressure.

67. The method of claim 48, comprising using attachment to rebar to resist concrete forming pressure.

68. The method of claim 48, comprising using controlled magnetic force to resist concrete forming pressure.

69. The method of claim 48, wherein one of more of a floor framing member is pre-situated, with anchors attached, before concrete placement.

70. The method of claim 48, wherein a pre-situated floor framing member is utilized to define the concrete wall plane.

71. The method of claim 48, wherein a device that collocates the relative positions of pre-situated framing member relative to the backing plane also provides permanent anchorage of the wall to a diaphragm.

72. The method of claim 48, wherein rebar is utilized to support a pre-situated floor member.

73. The method of claim 48, wherein ties for cladding are cast into the concrete wall.

74. The method of claim 48, wherein an RFID reader, and RFID tags are placed onto locations defining boundaries of the concrete placement, to allow determination of boundary locations electronically.

75. The method of claim 48, wherein an RFID reader, and RFID tags are placed onto locations defining an element that is cast into concrete, for subsequent location of the element.

76. The method of claim 48, wherein the placement device has an RFID reader, and RFID tags are placed onto locations of obstructions to allow electronic determination of a tool path that avoids the obstruction.

77. The method of claim 48, being automated.
